(19) United States
(12) Patent Application Publication
(10) Pub. No.: US 2015/0171764 A1
(43) Pub. Date: Jun. 18, 2015

(54) POWER CONVERSION APPARATUS

(71) Applicant: KABUSHIKI KAISHA YASKAWA DENKI, Kitakyushu-shi (JP)

(72) Inventors: Yu UJITA, Kitakyushu-shi (JP); Tomokazu HONDA, Kitakyushu-shi (JP); Akira SASAKI, Kitakyushu-shi (JP); Yoshifumi YAMAGUCHI, Kitakyushu-shi (JP); Kiyonori KOGUMA, Kitakyushu-shi (JP); Kunihiro TAKENAKA, Kitakyushu-shi (JP)

(73) Assignee: KABUSHIKI KAISHA YASKAWA DENKI, Kitakyushu-shi (JP)

(21) Appl. No.: 14/633,134

(22) Filed: Feb. 27, 2015

Related U.S. Application Data
(63) Continuation of application No. PCT/JP2012/071862, filed on Aug. 29, 2012.

(51) Int. Cl. H02M 7/00; H02M 7/5387

(52) U.S. Cl. CPC H02M 7/003; H02M 7/5387

(57) ABSTRACT

A power conversion apparatus includes: a horizontal switching element with a front face and a rear face, the horizontal switching element including a first electrode and a second electrode on a front face side; a snubber capacitor; and a connecting conductor arranged to be interposed between the horizontal switching element and the snubber capacitor and electrically connecting the horizontal switching element to the snubber capacitor.

### CROSS-REFERENCE TO RELATED APPLICATION

The present application is a continuation application of International Application No. PCT/JP2012/071862, filed Aug. 29, 2012, the entire content of which is hereby incorporated by reference.

### BACKGROUND

1. Technical Field

Embodiments of this disclosure relate to a power conversion apparatus.

2. Description of the Related Art

Conventionally, a power conversion apparatus having horizontal switching elements and snubber capacitors has been known. Such a power conversion apparatus is disclosed in JP-A-2011-67045, for example.

An inverter apparatus (power conversion apparatus) disclosed in JP-A-2011-67045 includes a metallic substrate and a dielectric substrate arranged to be opposed to each other, MOSFETs (horizontal switching elements), and snubber capacitors. In this inverter apparatus, the upper face side of the snubber capacitors and the side face side of the MOSFETs arranged under the snubber capacitors are connected by a plate-shaped wiring portion.

### SUMMARY

A power conversion apparatus includes: a horizontal switching element with a front face and a rear face, the horizontal switching element including a first electrode and a second electrode on a front face side; a snubber capacitor; and a connecting conductor arranged to be interposed between the horizontal switching element and the snubber capacitor and electrically connecting the horizontal switching element to the snubber capacitor.

### BRIEF DESCRIPTION OF THE DRAWINGS

FIG. 1 is a circuit diagram of a three-phase inverter apparatus including a power module according to a first embodiment;

FIG. 2 is a plan view of the power module according to the first embodiment as viewed from the top;

FIG. 3 is a cross-sectional view taken along the line 150-150 of FIG. 2;

FIG. 4 is a plan view of a first substrate of the power module according to the first embodiment as viewed from the lower face side;

FIG. 5 is a plan view of the first substrate illustrated in FIG. 4 as viewed from the upper face side;

FIG. 6 is a perspective view of the first substrate illustrated in FIGS. 4 and 5 as viewed from the upper face side;

FIG. 7 is a plan view of a second substrate of the power module according to the first embodiment as viewed from the upper face side;

FIG. 8 is a plan view of the second substrate illustrated in FIG. 7 as viewed from the lower face side;

FIG. 9 is a perspective view of the second substrate illustrated in FIGS. 7 and 8 as viewed from the lower face side;

FIG. 10 is a plan view of a first horizontal switching element and a second horizontal switching element according to the first embodiment, as viewed from the side of a front face on which a drain electrode, a source electrode, and a gate electrode are provided;

FIG. 11 is a plan view of the first horizontal switching element and the second horizontal switching element illustrated in FIG. 10 as viewed from the rear face side;

FIG. 12 is a cross-sectional view taken along the line 151-151 of FIGS. 10 and 11;

FIG. 13 is a plan view of a first controlling switching element and a second controlling switching element according to the first embodiment as viewed from the side of a front face on which a source electrode and a gate electrode are provided;

FIG. 14 is a plan view of the first controlling switching element and the second controlling switching element illustrated in FIG. 13 as viewed from the side of a rear face on which a drain electrode is provided;

FIG. 15 is a cross-sectional view taken along the line 152-152 of FIGS. 13 and 14;

FIG. 16 is a view for describing a current path of a current flowing inside the power module illustrated in FIG. 3;

FIG. 17 is a plan view of a power module according to a second embodiment as viewed from the top;

FIG. 18 is a cross-sectional view taken along the line 153-153 of FIG. 17;

FIG. 19 is a cross-sectional view taken along the line 154-154 of FIG. 17;

FIG. 20 is a cross-sectional view taken along the line 155-155 of FIG. 17;

FIG. 21 is a plan view of a first substrate of the power module according to the second embodiment as viewed from the upper face side;

FIG. 22 is a perspective view of the first substrate illustrated in FIG. 21 as viewed from the upper face side;

FIG. 23 is a plan view of a second substrate of the power module according to the second embodiment as viewed from the upper face side;

FIG. 24 is a plan view of the second substrate illustrated in FIG. 23 as viewed from the lower face side;

FIG. 25 is a perspective view of the second substrate illustrated in FIG. 23 and FIG. 24 as viewed from the lower face side;

FIG. 26 is a view for describing a current path of a current flowing inside the power module illustrated in FIG. 18;

FIG. 27 is a plan view of a power module according to a third embodiment as viewed from the top;

FIG. 28 is a cross-sectional view taken along the line 156-156 of FIG. 27;

FIG. 29 is a cross-sectional view taken along the line 157-157 of FIG. 27;

FIG. 30 is a cross-sectional view taken along the line 158-158 of FIG. 27;

FIG. 31 is a plan view of a first substrate of the power module according to the third embodiment as viewed from the upper face side;

FIG. 32 is a perspective view of the first substrate illustrated in FIG. 31 as viewed from the upper face side;

FIG. 33 is a plan view of a second substrate of the power module according to the third embodiment as viewed from the upper face side;

FIG. 34 is a plan view of the second substrate illustrated in FIG. 33 as viewed from the lower face side;

FIG. 35 is a perspective view of the second substrate illustrated in FIG. 33 and FIG. 34 as viewed from the lower face side;

FIG. 36 is a cross-sectional view taken along the line 159-159 of FIG. 35; and

FIG. 37 is a view for describing a current path of a current flowing inside the power module illustrated in FIG. 28.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A power conversion apparatus according to one aspect includes: a horizontal switching element with a front face and a rear face, the horizontal switching element including a first electrode and a second electrode on a front face side; a snubber capacitor; and a connecting conductor arranged to be interposed between the horizontal switching element and the snubber capacitor and electrically connecting the horizontal switching element to the snubber capacitor.

Since the power conversion apparatus according to one aspect has the above-described configuration, when the snubber capacitor is provided on the upper side and the horizontal switching element is provided on the lower side, for example, the current flowing between the snubber capacitor and the horizontal switching element flows from the lower face side of the snubber capacitor to the upper face side of the horizontal switching element (or from the upper face side of the horizontal switching element to the lower face side of the snubber capacitor) via the connecting conductor arranged so as to be interposed between the horizontal switching element and the snubber capacitor. Thus, a current path between the snubber capacitor and the horizontal switching element can be shortened as compared with the case where the current flows via the wiring that connects the upper face side of the snubber capacitor provided on the upper side and the side face side of the horizontal switching element provided on the lower side. As a result, wiring inductance between the snubber capacitor and the horizontal switching element can be reduced.

Embodiments will be described below with reference to the drawings.

### First Embodiment

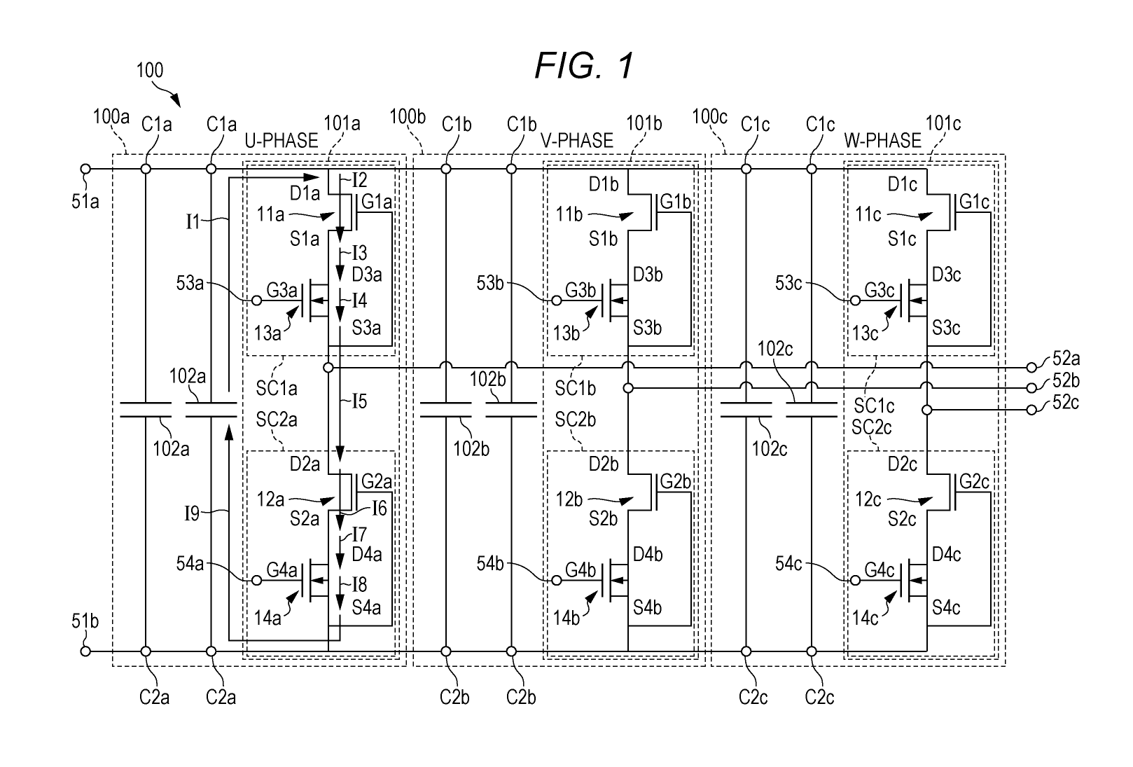

First, with reference to FIG. 1, the configuration of a three-phase inverter apparatus 100 including power modules 100a, 100b, and 100c according to the first embodiment will be described. It is noted that the power modules 100a to 100c and the three-phase inverter apparatus 100 are an example of the “power conversion apparatus.”

As illustrated in FIG. 1, the three-phase inverter apparatus 100 has the three power modules 100a, 100b, and 100c electrically connected in parallel. The power modules 100a, 100b, and 100c perform power conversion of a U-phase, a V-phase, and a W-phase, respectively.

The power modules 100a, 100b, and 100c are configured to convert the direct current power inputted from a direct current power source (not shown) via input terminals 51a and 51b into the alternating current power of three phases (U-phase, V-phase, and W-phase), respectively. Further, the power modules 100a, 100b, and 100c are configured to output the U-phase, V-phase, and W-phase alternating current power converted as described above to the outside via output terminals 52a, 52b, and 52c, respectively. It is noted that the output terminals 52a to 52c are connected to a motor (not shown) or the like.

Further, the power modules 100a, 100b, and 100c have half-bridge circuits 101a, 101b, and 101c and snubber capacitors 102a, 102b, and 102c which are electrically connected in parallel to the half-bridge circuits, respectively, and each of which includes two snubber capacitors.

The half-bridge circuit 101a includes two horizontal switching elements (a first horizontal switching element 11a and a second horizontal switching element 12a) and two controlling switching elements (a first controlling switching element 13a and a second controlling switching element 14a) cascode-connected to each of the two horizontal switching elements. It is noted that each of the first horizontal switching element 11a and the second horizontal switching element 12a is a normally-on switching element. That is, the first horizontal switching element 11a and the second horizontal switching element 12a are configured such that, when the voltage applied to gate electrodes G1a and G2a is 0 V, a current flows between a drain electrode D1a and a source electrode S1a and between a drain electrode D2a and a source electrode S2a. Further, each of the first controlling switching element 13a and the second controlling switching element 14a is a normally-off switching element. That is, the first controlling switching element 13a and the second controlling switching element 14a are configured such that, when the voltage applied to gate electrodes G3a and G4a is 0 V, no current flows between a drain electrode D3a and a source electrode S3a and between a drain electrode D4a and a source electrode S4a.

Here, in the first embodiment, the gate electrode G1a (G2a) of the first horizontal switching element 11a (the second horizontal switching element 12a) is connected to the source electrode S3a (S4a) of the first controlling switching element 13a (the second controlling switching element 14a). Thereby, the first controlling switching element 13a (the second controlling switching element 14a) is configured to control the driving (switching) of the first horizontal switching element 11a (the second horizontal switching element 12a) by switching based on a control signal inputted from a control terminal 53a (54a). As a result, a switching circuit SC1a (SC2a) including the normally-on first horizontal switching element 11a (second horizontal switching element 12a) and the normally-off first controlling switching element 13a (second controlling switching element 14a) as a whole is configured to be controlled as a normally-off switching circuit.

Further, similarly to the above-described half-bridge circuit 101a, the half-bridge circuit 101b includes two normally-on horizontal switching elements (a first horizontal switching element 11b and a second horizontal switching element 12b). The half-bridge circuit 101b further includes two normally-off controlling switching elements (a first controlling switching element 13b and a second controlling switching element 14b) cascode-connected to each of the two horizontal switching elements. Further, the normally-on first horizontal switching element 11b (second horizontal switching element 12b) and the normally-off first controlling switching element 13b (second controlling switching element 14b) configure a normally-off switching circuit SC1b (SC2b). It is noted that the first controlling switching element 13b (the second controlling switching element 14b) is configured to control the switching of the first horizontal switching element 11b (the second horizontal switching element 12b) by switching based on a control signal inputted from a control terminal 53b (54b).

Further, similarly to the above-described half-bridge circuits 101a and 101b, the half-bridge circuit 101c includes two normally-on horizontal switching elements (a first horizontal switching element 11c and a second horizontal switching element 12c). The half-bridge circuit 101c further includes two normally-off controlling switching elements (a first controlling switching element 13c and a second controlling switching element 14c) cascode-connected to each of the two horizontal switching elements. Further, the normally-on first horizontal switching element 11c (second horizontal switching element 12c) and the normally-off first controlling switching element 13c (second controlling switching element 14c) configure a normally-off switching circuit SC1c (SC2c). It is noted that the first controlling switching element 13c (the second controlling switching element 14c) is configured to control the switching of the first horizontal switching element 11c (the second horizontal switching element 12c) by switching based on a control signal inputted from a control terminal 53c (54c).

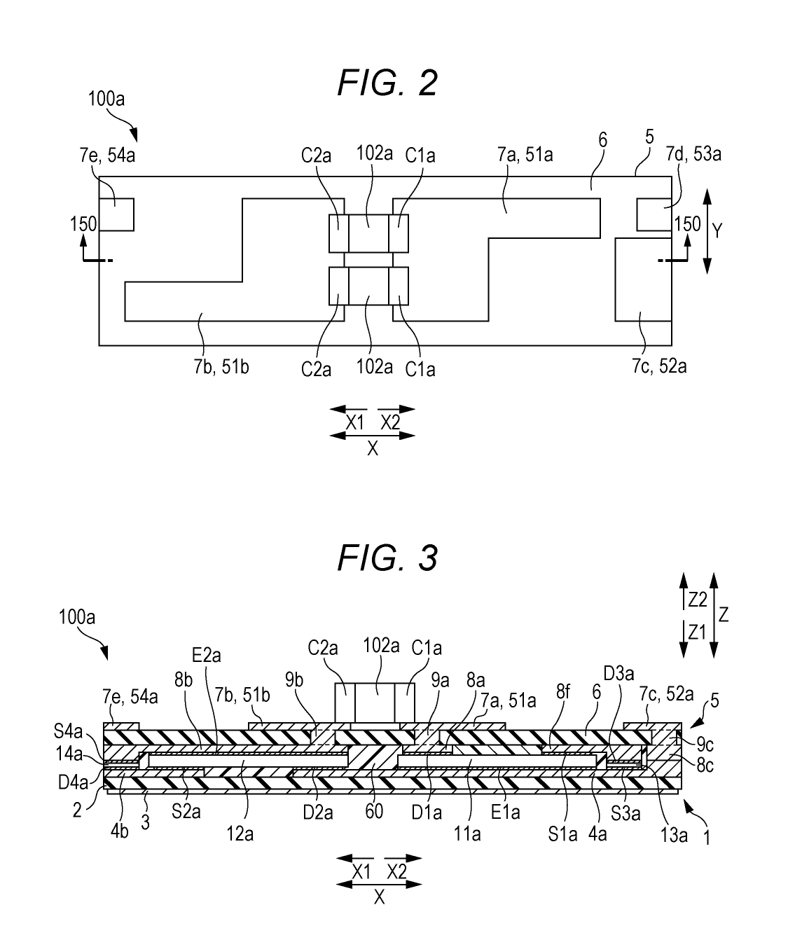

Next, with reference to FIG. 2 to FIG. 15, the specific configuration (structure) of the power modules 100a, 100b, and 100c according to the first embodiment will be described. It is noted that the power modules 100a, 100b, and 100c have substantially the same configuration, respectively. Therefore, only the power module 100a, which performs the U-phase power conversion, will be described below.

As illustrated in FIGS. 2 and 3, the power module 100a includes a first substrate 1, the two horizontal switching elements (the first horizontal switching element 11a and the second horizontal switching element 12a), the two controlling switching elements (the first controlling switching element 13a and the second controlling switching element 14a), the two snubber capacitors 102a, and a second substrate 5.

As illustrated in FIG. 3, the first substrate 1 and the second substrate 5 are arranged to be opposed to each other and spaced apart from each other with a predetermined spacing in the vertical direction (the Z direction). Specifically, while the first substrate 1 is arranged on the lower side (the arrow Z1 direction side), the second substrate 5 is arranged on the upper side (the arrow Z2 direction side). Further, the first horizontal switching element 11a, the second horizontal switching element 12a, the first controlling switching element 13a, and the second controlling switching element 14a are arranged between the upper face (the front face on the arrow Z2 direction side) of the first substrate 1 and the lower face (the rear face on the arrow Z1 direction side) of the second substrate 5. Further, the snubber capacitors 102a are arranged on the upper face of the second substrate 5. Further, a seal resin 60 is filled between the upper face of the first substrate 1 and the lower face of the second substrate 5.

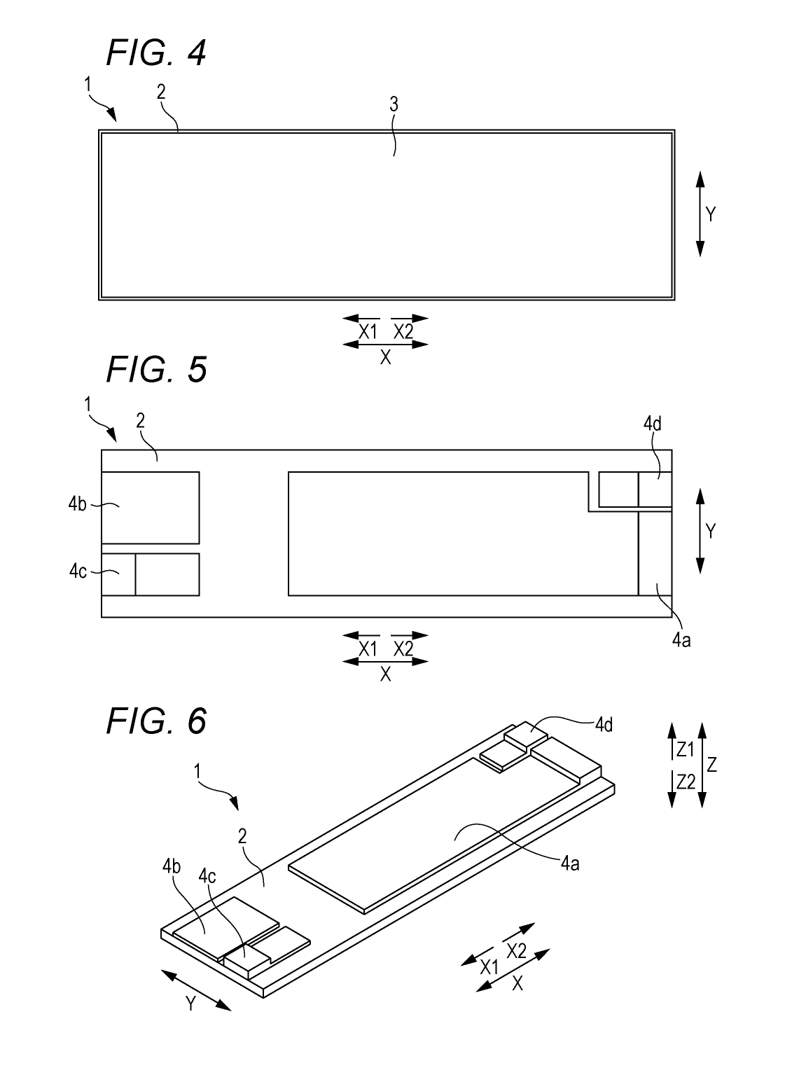

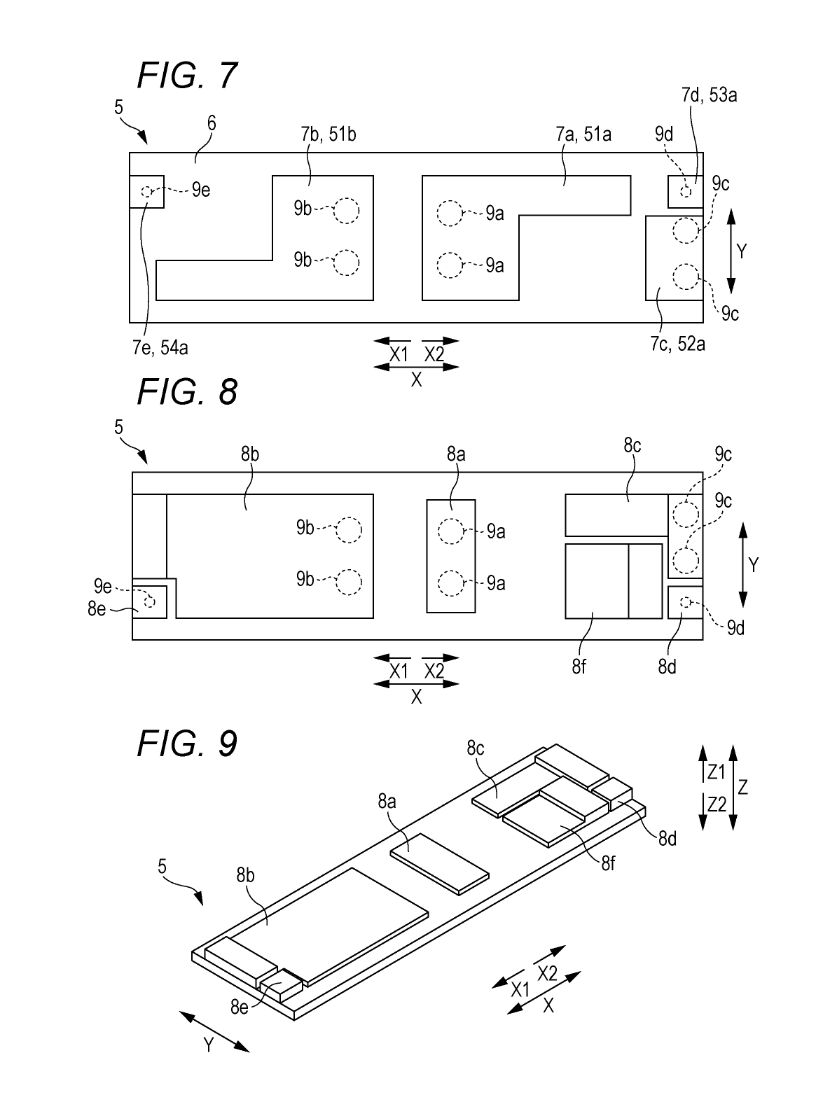

As illustrated in FIGS. 4 to 6, the first substrate 1 includes an insulating sheet 2, a heat radiation layer 3 formed on the lower face (the face on the arrow Z1 direction side) of the insulating sheet 2, and four conductive patterns 4a, 4b, 4c, and 4d formed on the upper face (the face on the arrow Z2 direction side) of the insulating sheet 2. Further, as illustrated in FIGS. 7 to 9, the second substrate 5 includes an insulating sheet 6, five conductive patterns 7a, 7b, 7c, 7d, and 7e formed on the upper face of the insulating sheet 6 (the front face of the second substrate 5), and six conductive patterns 8a, 8b, 8c, 8d, 8e, and 8f formed on the lower face of the insulating sheet 6 (the rear face of the second substrate 5). Here, the conductive patterns 7a, 7b, 7c, 7d, and 7e and the conductive patterns 8a, 8b, 8c, 8d, and 8e are electrically connected via pillar conductors 9a, 9b, 9c, 9d, and 9e, respectively. The pillar conductors 9a, 9b, 9c, 9d, and 9e are provided so as to penetrate the insulating sheet 2 in the vertical direction (the Z direction). It is noted that the conductive patterns 7a, 7b, 7c, 7d, and 7e and the conductive patterns 8a, 8b, 8c, 8d, and 8e may be electrically connected via hollow conductors such as through vias, respectively, in place of the pillar conductors 9a, 9b, 9c, 9d, and 9e.

Here, in the first embodiment, as illustrated in FIG. 3, the second substrate 5 is arranged so as to be interposed between the snubber capacitor 102a and the first and second horizontal switching elements 11a and 12a. That is, the snubber capacitor 102a is arranged on the upper side (the arrow Z2 direction side) of the second substrate 5. On the other hand, the first horizontal switching element 11a and the second horizontal switching element 12a are arranged on the lower side (the arrow Z1 direction side) of the second substrate 5. Thereby, the conductive patterns 7a to 7e and 8a to 8f and the pillar conductors 9a to 9e provided to the second substrate 5 are arranged so as to be interposed between the snubber capacitor 102a and the first and second horizontal switching elements 11a and 12a. It is noted that the conductive patterns 7a to 7e and 8a to 8f and the pillar conductors 9a to 9e are an example of the “connecting conductor.”

Further, as illustrated in FIG. 3, one electrode C1a of the snubber capacitor 102a is connected to the conductive pattern 7a on the upper face (the face on the arrow Z2 direction side) of the second substrate 5. The conductive pattern 7a is connected to a drain electrode D1a of the first horizontal switching element 11a via the pillar conductor 9a and the conductive pattern 8a on the lower face (the face on the arrow Z1 direction side) of the second substrate 5. Thereby, the conductive patterns 7a and 8a and the pillar conductor 9a are arranged so as to be interposed between the one electrode C1a of the snubber capacitor 102a and the drain electrode D1a of the first horizontal switching element 11a. It is noted that the conductive patterns 7a and 8a are examples of the “first conductive pattern” and the “second conductive pattern”, respectively. Further, the conductive patterns 7a and 8a and the pillar conductor 9a are an example of the “first connecting conductor.”

Further, the other electrode C2a of the snubber capacitor 102a is connected to the conductive pattern 7b on the upper face (the face on the arrow Z2 direction side) of the second substrate 5. The conductive pattern 7b is connected to a source electrode S2a of the second horizontal switching element 12a via the pillar conductor 9b, the conductive pattern 8b on the lower face (the face on the arrow Z1 direction side) of the second substrate 5, the second controlling switching element 14a, and the conductive pattern 4b on the upper face of the first substrate 1. Thereby, the conductive patterns 7b and 8b and the pillar conductor 9b are arranged so as to be interposed between the other electrode C2a of the snubber capacitor 102a and the source electrode S2a of the second horizontal switching element 12a. It is noted that the conductive patterns 7b and 8b are examples of the “first conductive pattern” and the “second conductive pattern”, respectively. Further, the conductive patterns 7b and 8b and the pillar conductor 9b are an example of the “second connecting conductor.”

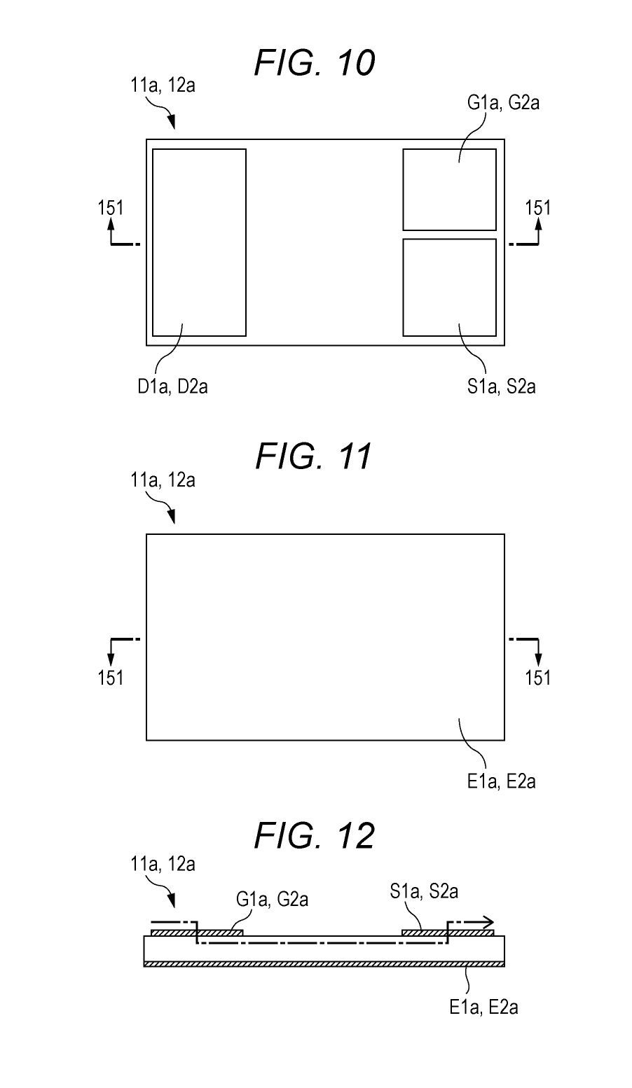

Here, as illustrated in FIGS. 10 to 12, the first horizontal switching element 11a and the second horizontal switching element 12a respectively include a semiconductor bear chip having electrodes on its front face and its rear face. Specifically, the first horizontal switching element 11a and the second horizontal switching element 12a respectively include a semiconductor bear chip of a MOSFET (field effect transistor) having three electrodes (gate electrodes G1a and G2a, source electrodes S1a and S2a, and drain electrodes D1a and D2a). It is noted that the source electrode S1a (S2a) and the drain electrode D1a (D2a) are examples of the “first electrode” and the “second electrode.” Further, the gate electrode G1a (G2a) is an example of the “third electrode.”

Further, the first horizontal switching element 11a (the second horizontal switching element 12a) is configured such that the gate electrode G1a (G2a), the source electrode S1a (S2a), and the drain electrode D1a (D2a) are provided on the face on the same side (the front face), respectively. Thereby, as illustrated by the dot-dashed line with the arrow in FIG. 12, a current flows in the horizontal direction (the direction parallel to the front face and the rear face) between the source electrode S1a (S2a) and the drain electrode D1a (D2a) in the vicinity of the front face inside the first horizontal switching element 11a (the second horizontal switching element 12a). It is noted that the first horizontal switching element 11a (the second horizontal switching element 12a) has an electrode E1a (E2a) on the face (the rear face) opposite to the face (the front face) on which the gate electrode G1a (G2a), the source electrode S1a (S2a), and the drain electrode D1a (D2a) are provided.

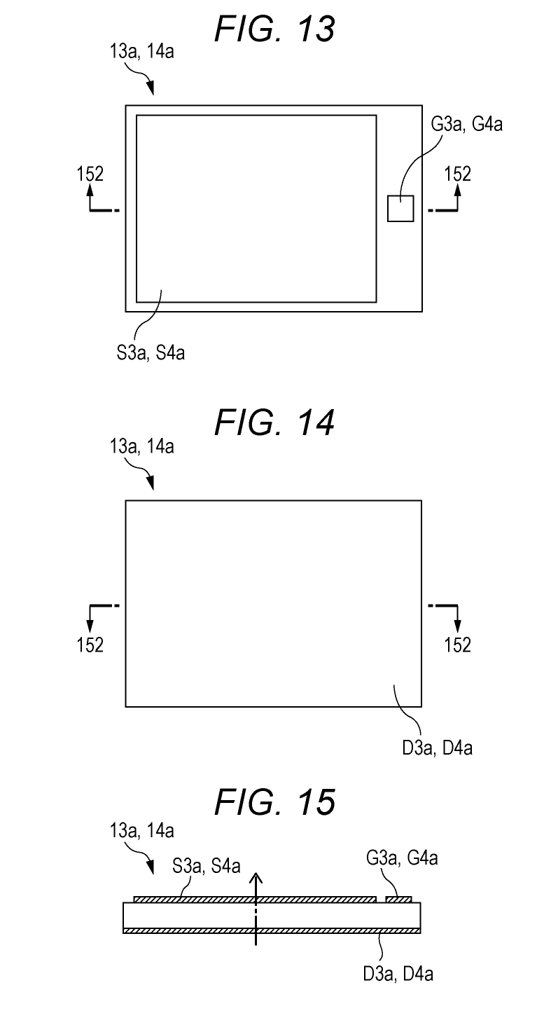

Further, as illustrated in FIGS. 13 to 15, similarly to the horizontal switching element 11a (the second horizontal switching element 12a) described above, the first controlling switching element 13a (the second controlling switching element 14a) also includes a semiconductor bear chip having a front face and a rear face. Further, the first controlling switching element 13a (the second controlling switching element 14a) includes a gate electrode G3a (G4a), a source electrode S3a (S4a), and a drain electrode D3a (D4a). Here, unlike the first horizontal switching element 11a (the second horizontal switching element 12a) described above, the first controlling switching element 13a (the second controlling switching element 14a) is configured such that the source electrode S3a (S4a) and the drain electrode D3a (D4a) are provided on the faces on the different sides from each other. Specifically, the source electrode S3a (S4a) is provided on the front face of the first controlling switching element 13a (the second controlling switching element 14a). On the other hand, the drain electrode D3a (D4a) is provided on the rear face of the first controlling switching element 13a (the second controlling switching element 14a). Thereby, as illustrated by the dot-dashed line with the arrow in FIG. 15, a current flows in the vertical direction (the direction orthogonal to the front face and the rear face) between the source electrode S3a (S4a) and the drain electrode D3a (D4a) inside the first controlling switching element 13a (the second controlling switching element 14a).

Here, as illustrated in FIG. 3, the first horizontal switching element 11a and the second horizontal switching element 12a are arranged on the upper face (the face on the arrow Z2 direction side) of the first substrate 1 such that their front faces face the opposite directions to each other. The drain electrode D1a, the source electrode S1a, and the gate electrode G1a on the front face side of the first horizontal switching element 11a are joined to the conductive patterns 8a, 8f, and 8c (see FIGS. 8 and 9) on the lower face (the face on the arrow Z1 direction side) of the second substrate 5 via a joining layer (not shown) including solder and the like, respectively. On the other hand, the drain electrode D2a, the source electrode S2a, and the gate electrode G2a on the front face side of the second horizontal switching element 12a are joined to the conductive patterns 4a, 4b, and 4c (see FIGS. 5 and 6) on the upper face of the first substrate 1 via a joining layer (not shown) including solder and the like, respectively. Further, the electrode E1a on the rear face side of the first horizontal switching element 11a is joined to the conductive pattern 4a on the upper face (the face on the arrow Z2 direction side) of the first substrate 1 via a joining layer (not shown) including solder and the like. On the other hand, the electrode E2a on the rear face side of the second horizontal switching element 12a is joined to the conductive pattern 8b on the lower face of the second substrate 5 via a joining layer (not shown) including solder and the like.

Further, as illustrated in FIG. 3, the first controlling switching element 13a and the second controlling switching element 14a are arranged outside the first horizontal switching element 11a and the second horizontal switching element 12a, respectively. That is, the first controlling switching element 13a is arranged on the right side (on the arrow X2 direction side) of the first horizontal switching element 11a. The second controlling switching element 14a is arranged on the left side (on the arrow X1 direction side) of the second horizontal switching element 12a. It is noted that, similarly to the first horizontal switching element 11a and the second horizontal switching element 12a described above, the first controlling switching element 13a and the second controlling switching element 14a are arranged on the upper face (the face on the arrow Z2 direction side) of the first substrate 1 such that their front faces face the opposite directions to each other.

As illustrated in FIG. 3, the source electrode S3a and the gate electrode G3a on the front face side of the first controlling switching element 13a are joined to the conductive patterns 4d and 4a (see FIGS. 5 and 6) on the upper face (the face on the arrow Z2 direction side) of the first substrate 1 via a joining layer (not shown) including solder and the like, respectively. On the other hand, the source electrode S4a and the gate electrode G4a on the front face side of the second controlling switching element 14a are joined to the conductive patterns 8b and 8e (see FIGS. 8 and 9) on the lower face of the second substrate 5 via a joining layer (not shown) including solder and the like, respectively. Further, the drain electrode D3a on the rear face side of the first controlling switching element 13a is joined to the conductive pattern 8f (see FIGS. 8 and 9) on the lower face (the face on the arrow Z1 direction side) of the second substrate 5 via a joining layer (not shown) including solder and the like. On the other hand, the drain electrode D4a on the rear face side of the second controlling switching element 14a is joined to the conductive pattern 4b (see FIGS. 5 and 6) on the upper face of the first substrate 1 via a joining layer (not shown) including solder and the like.

It is noted that, as illustrated in FIGS. 8 and 9, a protrusion part protruding to the first substrate 1 side (the arrow Z1 direction side) is provided near the right end (the arrow X2 directions side) of the conductive pattern 8c on the lower face (the face on the arrow Z1 direction side) of the second substrate 5. Further, as illustrated in FIGS. 5 and 6, a protrusion part protruding to the second substrate 5 side (the arrow Z2 direction side) is provided near the right end of the conductive pattern 4a on the upper face (the face on the arrow Z2 direction side) of the first substrate 1. Further, the protrusion part of the conductive pattern 8c and the protrusion part of the conductive pattern 4a are joined via a joining layer (not shown) including solder and the like. Thereby, the gate electrode G1a of the first horizontal switching element 11a joined to the conductive pattern 8c and the source electrode S3a of the first controlling switching element 13a joined to the conductive pattern 4a are electrically connected via the conductive pattern 4a and the conductive pattern 8c.

Further, as illustrated in FIGS. 5 and 6, a protrusion part protruding to the second substrate 5 side (the arrow Z2 direction side) is provided near the left end (the arrow X1 directions side) of the conductive pattern 4c on the upper face (the face on the arrow Z2 direction side) of the first substrate 1. Further, as illustrated in FIGS. 8 and 9, a protrusion part protruding to the first substrate 1 side (the arrow Z1 direction side) is provided near the left end of the conductive pattern 8b on the lower face (the face on the arrow Z1 direction side) of the second substrate 5. Further, the protrusion part of the conductive pattern 4c and the protrusion part of the conductive pattern 8b are joined via a joining layer (not shown) including solder and the like. Thereby, the gate electrode G2a of the second horizontal switching element 12a joined to the conductive pattern 4c and the source electrode S4a of the second controlling switching element 14a joined to the conductive pattern 8b are electrically connected via the conductive patterns 4c and 8b.

Further, as illustrated in FIGS. 5 and 6, a protrusion part protruding to the second substrate 5 side (the arrow Z2 direction side) is provided near the right end (the arrow X2 direction side) of the conductive pattern 4d on the upper face (the face on the arrow Z2 direction side) of the first substrate 1. Further, the protrusion part of the conductive pattern 4d and the conductive pattern 8d on the lower face (the face on the arrow Z1 direction side) of the second substrate 5 are joined via a joining layer (not shown) including solder and the like. Further, as illustrated in FIGS. 8 and 9, a protrusion part protruding to the first substrate 1 side (the arrow Z1 direction side) is provided near the right end of the conductive pattern 8f on the lower face (the face on the arrow Z1 direction side) of the second substrate 5. As illustrated in FIG. 3, the protrusion part of the conductive pattern 8f is provided to electrically connect the source electrode S1a of the first horizontal switching element 11a to the drain electrode D3a of the first controlling switching element 13a. The source electrode S1a and the drain electrode D3a have mutually different heights from the upper face of the first substrate 1 (heights in the Z direction).

With the above-described configuration, in the first embodiment, the conductive pattern 7a of the second substrate 5 is connected to the drain electrode D1a of the first horizontal switching element 11a via the pillar conductor 9a and the conductive pattern 8a. Therefore, the conductive pattern 7a configures the input terminal 51a (see FIG. 1) connected to the direct current power source (not shown). Further, the conductive pattern 7b of the second substrate 5 is connected to the source electrode S4a of the second controlling switching element 14a via the pillar conductor 9b and the conductive pattern 8b. Therefore, the conductive pattern 7b configures the input terminal 51b (see FIG. 1) connected to the direct current power source (not shown).

Further, the conductive pattern 7c of the second substrate 5 is connected to the source electrode S3a of the first controlling switching element 13a and the drain electrode D2a of the second horizontal switching element 12a via the pillar conductor 9c, the conductive pattern 8c, and the conductive pattern 4a of the first substrate 1. Therefore, the conductive pattern 7c configures the output terminal 52a of the U-phase (see FIG. 1) connected to a motor (not shown) and the like.

Further, the conductive pattern 7d of the second substrate 5 is connected to the gate electrode G3a of the first controlling switching element 13a via the pillar conductor 9d, the conductive pattern 8d, and the conductive pattern 4d of the first substrate 1. Therefore, the conductive pattern 7d configures the control terminal 53a (see FIG. 1) to which a control signal for switching the first controlling switching element 13a is inputted. Further, the conductive pattern 7e of the second substrate 5 is connected to the gate electrode G4a of the second controlling switching element 14a via the pillar conductor 9e and the conductive pattern 8e. Therefore, the conductive pattern 7e configures the control terminal 54a (see FIG. 1) to which a control signal for switching the second controlling switching element 14a is inputted.

It is noted that, in the first embodiment, as illustrated in FIG. 2, the two snubber capacitors 102a are arranged so as to be bridged over the conductive patterns 7a and 7b on the upper face (the face on the arrow Z2 direction side) of the second substrate 5. Specifically, one electrodes C1a of the two snubber capacitors 102a are joined to the conductive pattern 7a via a joining member (not shown) including solder and the like. Further, the other electrodes C2a of the two snubber capacitors 102a are joined to the conductive pattern 7b via a joining member (not shown) including solder and the like. Thereby, the conductive patterns 7a and 7b are shared by the two snubber capacitors 102a.

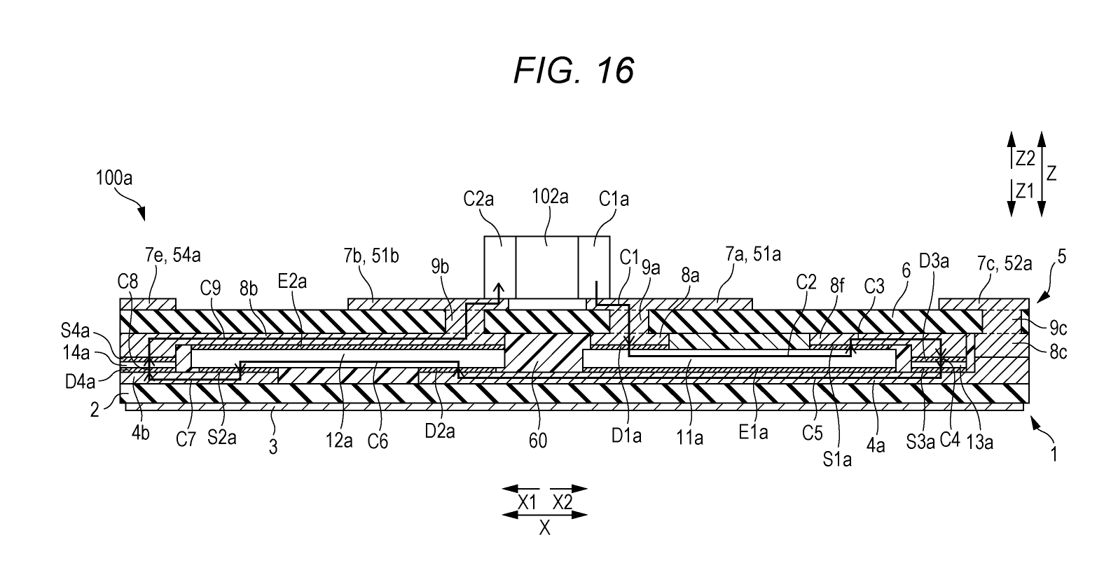

Next, with reference to FIGS. 1 and 16, current paths C1, C2, C3, C4, C5, C6, C7, C8, and C9 (see FIG. 16) of the power module 100a according to the first embodiment will be described. The current paths C1, C2, C3, C4, C5, C6, C7, C8, and C9 are formed by a current of I1, I2, I3, I4, I5, I6, I7, I8, and I9 (see FIG. 1) flowing between the snubber capacitors 102a and the first and second horizontal switching elements 11a and 12a, respectively.

As illustrated in FIG. 16, the current I1 flowing from the one electrode C1a of the snubber capacitor 102a to the drain electrode D1a of the first horizontal switching element 11a (see FIG. 1) flows in the downward direction (the arrow Z1 direction) via the conductive pattern 7a, the pillar conductor 9a, and the conductive pattern 8a. Thereby, the current path C1 extending in the direction substantially orthogonal to the first substrate 1 and the second substrate 5 is formed. Further, the current I2 flowing from the drain electrode D1a to the source electrode S1a of the first horizontal switching element 11a (see FIG. 1) flows in the right direction (the arrow X2 direction) along the front face of the horizontal switching element 11a. Thereby, the current path C2 extending in the direction substantially parallel to the first substrate 1 and the second substrate 5 is formed.

Next, the current I3 flowing from the source electrode S1a of the first horizontal switching element 11a to the drain electrode D3a of the first controlling switching element 13a (see FIG. 1) flows in the right direction (the arrow X2 direction) via a flat portion of the conductive pattern 8f. The current I3 then flows in the downward direction (the arrow Z1 direction) via the protrusion part provided to the right end (the arrow X2 direction side) of the conductive pattern 8f. Thereby, the current path C3 has a longer section extending in the direction substantially parallel to the first substrate 1 and the second substrate 5, and a shorter section extending in the direction substantially orthogonal to the first substrate 1 and the second substrate 5.

Next, the current I4 flowing from the drain electrode D3a to the source electrode S3a of the first controlling switching element 13a (see FIG. 1) flows inside the first controlling switching element 13a in the downward direction (the arrow Z1 direction) so as to be substantially orthogonal to the front face and the rear face of the first controlling switching element 13a. Thereby, the current path C4 extending in the direction substantially orthogonal to the first substrate 1 and the second substrate 5 is formed. Further, the current I5 flowing from the source electrode S3a of the first controlling switching element 13a to the drain electrode D2a of the second horizontal switching element 12a (see FIG. 1) flows in the left direction (the arrow X1 direction) via the conductive pattern 4a. Thereby, the current path C5 extending in the direction substantially parallel to the first substrate 1 and the second substrate 5 is formed.

Next, the current I6 flowing from the drain electrode D2a to the source electrode S2a of the second horizontal switching element 12a (see FIG. 1) flows in the left direction (the arrow X1 direction) along the front face of the second horizontal switching element 12a. Thereby, the current path C6 extending in the direction substantially parallel to the first substrate 1 and the second substrate 5 is formed. Further, the current I7 flowing from the source electrode S2a of the second horizontal switching element 12a to the drain electrode D4a of the second controlling switching element 14a (see FIG. 1) flows in the left direction (the arrow X1 direction) via the conductive pattern 4b. Thereby, the current path C7 extending in the direction substantially parallel to the first substrate 1 and the second substrate 5 is formed.

Next, the current I8 flowing from the drain electrode D4a to the source electrode S4a of the second controlling switching element 14a (see FIG. 1) flows inside the second controlling switching element 14a in the upward direction (the arrow Z2 direction) so as to be substantially orthogonal to the front face and the rear face of the second controlling switching element 14a. Thereby, the current path C8 extending in the direction substantially orthogonal to the first substrate 1 and the second substrate 5 is formed. Further, the current I9 flowing from the source electrode S4a of the second controlling switching element 14a to the other electrode C2a of the snubber capacitor 102a (see FIG. 1) flows in the upward direction (the arrow Z2 direction) via the protrusion part on the left end (the arrow X1 direction side) of the conductive pattern 8b. The current I9 then flows in the right direction (the arrow X2 direction) via the flat portion of the conductive pattern 8b. The current, which has flown in the right direction via the flat portion of the conductive pattern 8b as described above, flows in the upward direction (the arrow Z2 direction) via the pillar conductor 9b and the conductive pattern 7b. Thereby, the current path C9 has a longer section extending in the direction substantially parallel to the first substrate 1 and the second substrate 5, and a shorter section extending in the direction substantially orthogonal to the first substrate 1 and the second substrate 5.

As described above, the current paths C1 to C9 (see FIG. 16) are formed by the current I1 to I9 flowing between the snubber capacitor 102a and the first and second horizontal switching elements 11a and 12a (see FIG. 1). The current paths C1 to C9 include the current paths C2 and C5. The current path C2 is arranged between the drain electrode D1a and the source electrode S1a of the first horizontal switching element 11a. In the current path C2, the current flows in the horizontal direction (the arrow X2 direction) along the front face of the first horizontal switching element 11a. Further, the direction of the current in the current path C5 is substantially opposite to that in the current path C2. The current paths C1 to C9 include the current paths C6 and C9. The current path C6 is arranged between the drain electrode D2a and the source electrode S2a of the second horizontal switching element 12a. In the current path C6, the current flows in the horizontal direction (the arrow X1 direction) from along the front face of the second horizontal switching element 12a. The direction of the current in the current path C9 is substantially opposite to that in the current path C6. It is noted that the current paths C2 and C6 are an example of the “first current path” and the current paths C5 and C9 are an example of the “second current path.”

Here, the current path C2 (C6) and the current path C5 (C9) are arranged close to each other so as to be able to cancel the change in the magnetic flux generated due to the current flowing through these current paths C2 and C5 (C6 and C9). Specifically, the current path C2 (C6) and the current path C5 (C9) are spaced apart from each other by a distance that is substantially the same length as the thickness in the vertical direction (the Z direction) of the first horizontal switching element 11a and the second horizontal switching element 12a. It is noted that the current path C2 (C6) and the current path C5 (C9) are arranged to be opposed to each other.

In the first embodiment, the second substrate 5 includes the conductive patterns 7a to 7e, the conductive patterns 8a to 8f, and the pillar conductors 9a to 9e connecting the conductive patterns 7a to 7e and the conductive patterns 8a to 8e, as described above. The second substrate 5 is arranged to be interposed between the snubber capacitors 102a located on the upper side (the arrow Z2 direction side) and the first horizontal switching element 11a (the second horizontal switching element 12a) located on the lower side (the arrow Z1 direction side). Thereby, the current I1 flowing between the snubber capacitors 102a located on the upper side and the first horizontal switching element 11a located on the lower side (FIG. 1) flows from the lower face side of the snubber capacitors 102a to the upper face side of the first horizontal switching element 11a via the conductive patterns 7a and 8a and the pillar conductor 9a of the second substrate 5. Further, the current I9 flowing between the snubber capacitors 102a located on the upper side and the second horizontal switching element 12a located on the lower side (FIG. 1) flows from the upper face side of the second horizontal switching element 12a to the lower face side of the snubber capacitors 102a via the conductive patterns 7b and 8b and the pillar conductor 9b of the second substrate 5. As a result, a current path between the snubber capacitors 102a and the first horizontal switching element 11a (the second horizontal switching element 12a) can be shorter as compared with the case where the current flows via the wiring that connects the upper face side of the snubber capacitors 102a located on the upper side to the side face side of the first horizontal switching element 11a (the second horizontal switching element 12a) located on the lower side. Thus, a wiring inductance between the snubber capacitors 102a and the first horizontal switching element 11a (the second horizontal switching element 12a) can be reduced.

Further, in the first embodiment, the first controlling switching element 13a (the second controlling switching element 14a) controls the driving of the first horizontal switching element 11a (the second horizontal switching element 12a), as described above. The first controlling switching element 13a (the second controlling switching element 14a) is cascode-connected to the first horizontal switching element 11a (the second horizontal switching element 12a). Therefore, even when the first horizontal switching element 11a (the second horizontal switching element 12a) is of the normally-on type, the switching circuit SC1a (SC2a) including the first horizontal switching element 11a (the second horizontal switching element 12a) and the first controlling switching element 13a (the second controlling switching element 14a) can be controlled as the normally-off type as a whole by use of the normally-off first controlling switching element 13a (the second controlling switching element 14a). As a result, even when the voltages are applied to the input terminals 51a and 51b before the control signals are inputted to the control terminals 53a and 54a, no current flows in the switching circuits SC1a and SC2a. Accordingly, a short circuit between the input terminals 51a and 51b can be suppressed. Thus, the reliability of the power module 100a can be enhanced.

Further, in the first embodiment, the gate electrode G1a (G2a) for controlling the first horizontal switching element 11a (the second horizontal switching element 12a) is connected to the source electrode S3a (S4a) where the current of the first controlling switching element 13a (the second controlling switching element 14a) flows in or out, as described above. Thus, the driving of the first horizontal switching element 11a (the second horizontal switching element 12a) can be easily controlled by the first controlling switching element 13a (the second controlling switching element 14a).

Further, in the first embodiment, the current path C2 (see FIG. 16) is arranged between the drain electrode D1a and the source electrode S1a of the first horizontal switching element 11a as described above. In the current path C2, the current flows in the horizontal direction (the arrow X2 direction) along the front face of the first horizontal switching element 11a. Further, the direction of the current in the current path C5 is substantially opposite to that in the current path C2. The current path C2 and the current path C5 (see FIG. 16) are arranged close to each other so that the change in the magnetic flux can be cancelled. Further, the current path C6 is arranged between the drain electrode D2a and the source electrode S2a of the second horizontal switching element 12a as described above. In the current path C9 (see FIG. 16), the current flows in the horizontal direction (the arrow X1 direction) along the front face of the second horizontal switching element 12a. Further, the direction of the current in the current path C9 (see FIG. 16) is substantially opposite to that in the current path C6. The current path C6 and the current path C9 are arranged close to each other so that the change in the magnetic flux can be cancelled. Thereby, the changes in the magnetic flux generated in the current paths C2 and C6 of the current paths C1 to C9 in which the current flows between the snubber capacitors 102a and the first and second horizontal switching elements 11a and 12a (see FIG. 16) can be offset by the changes in the magnetic flux generated in the current paths C5 and C9, respectively. As a result, a wiring inductance between the snubber capacitors 102a and the first and second horizontal switching elements 11a and 12a can be reduced.

Further, in the first embodiment, the current path C2 (C6) and the current path C5 (C9) are arranged so as to be opposed to each other as described above. Thereby, the change in the magnetic flux generated in the current path C2 (C6) can be easily offset by the change in the magnetic flux generated in the current path C5 (C9). Thus, the wiring inductance between the snubber capacitors 102a and the first and second horizontal switching elements 11a and 12a can be easily reduced.

Further, in the first embodiment, the first horizontal switching element 11a and the second horizontal switching element 12a are arranged so as to be interposed between the first substrate 1 and the second substrate 5 (that is, the conductive patterns), as described above. Thus, the first horizontal switching element 11a and the second horizontal switching element 12a can be held in a mechanically stable state between the first substrate 1 and the second substrate 5.

Further, in the first embodiment, in addition to the first horizontal switching element 11a and the second horizontal switching element 12a, the first controlling switching element 13a and the second controlling switching element 14a are also arranged so as to be interposed between the first substrate 1 and the second substrate 5 (that is, the conductive patterns), as described above. Thus, the first controlling switching element 13a and the second controlling switching element 14a, in addition to the first horizontal switching element 11a and the second horizontal switching element 12a, can be held in a mechanically stable state between the first substrate 1 and the second substrate 5.

Further, in the first embodiment, the first horizontal switching element 11a and the second horizontal switching element 12a are arranged such that their front faces face the opposite directions to each other on the upper face (the face on the arrow Z2 direction side) of the first substrate 1, as described above. This allows for simplifying the process of joining the drain electrode D1a, the source electrode S1a, and the gate electrode G1a on the front face side of the first horizontal switching element 11a to the conductive patterns 8a, 8f, and 8c on the lower face (the face on the arrow Z1 direction side) of the second substrate 5, respectively. Further, it allows for simplifying the process for joining the drain electrode D2a, the source electrode S2a, and the gate electrode G2a on the front face side of the second horizontal switching element 12a to the conductive patterns 4a, 4b, and 4c on the upper face of the first substrate 1, respectively.

Further, in the first embodiment, the first controlling switching element 13a and the second controlling switching element 14a are arranged outside in the horizontal direction (the X direction) of the first horizontal switching element 11a and the second horizontal switching element 12a, respectively, as described above. Therefore, the first controlling switching element 13a and the second controlling switching element 14a can be arranged at the positions that are less likely to be subjected to the influence of the heat from the first horizontal switching element 11a and the second horizontal switching element 12a, as compared with the case where the first controlling switching element 13a and the second controlling switching element 14a are arranged inside the first horizontal switching element 11a and the second horizontal switching element 12a. As a result, the first controlling switching element 13a and the second controlling switching element 14a can be favorably operated.

Further, in the first embodiment, the heat radiation layer 3 is formed on the lower face (the face on the arrow Z1 direction side) of the first substrate 1, as described above. Thus, the heat radiation properties of the power module 100a can be enhanced by the heat radiation layer 3.

Further, in the first embodiment, the seal resin 60 is filled between the upper face (the face on the arrow Z2 direction) of the first substrate 1 and the lower face (the face on the arrow Z1 direction side) of the second substrate 5, as described above. Thus, the entry of foreign substances between the upper face of the first substrate 1 and the lower face of the second substrate 5 by the seal resin 60 can be suppressed. Further, the reliability of the insulation of the first substrate 1 and the second substrate 5 can be enhanced.

Further, in the first embodiment, the snubber capacitors 102a are connected to the conductive patterns 7a and 7b on the upper face (the face on the arrow Z2 direction side) of the second substrate 5, as described above. Further, the first horizontal switching element 11a and the second horizontal switching element 12a are connected to the conductive patterns 8a and 8b on the lower face (the face on the arrow Z1 direction side) of the second substrate 5, respectively. The conductive patterns 8a and 8b are electrically connected to the above-described conductive patterns 7a and 7b via the pillar conductors 9a and 9b. Thereby, the snubber capacitors 102a can be joined to the conductive patterns 7a and 7b having large joining areas. As a result, the process for joining the snubber capacitors 102a to the conductive patterns 7a and 7b can be simplified. Further, the configuration in which the second substrate 5 is interposed between the snubber capacitors 102a and the first and second horizontal switching elements 11a and 12a can be easily provided with a simple process.

Further, in the first embodiment, the conductive patterns 7a and 7b on the upper face (the face on the arrow Z2 direction side) of the second substrate 5 are shared by two of the one electrodes C1a and two of the other electrodes C2a of the two snubber capacitors 102a, respectively, as described above. Thereby, the structure of the second substrate 5 can be simplified, unlike the case where four conductive patterns corresponding to two of the one electrodes C1a and two of the other electrodes C2a of the two snubber capacitors 102a are provided.

### Second Embodiment

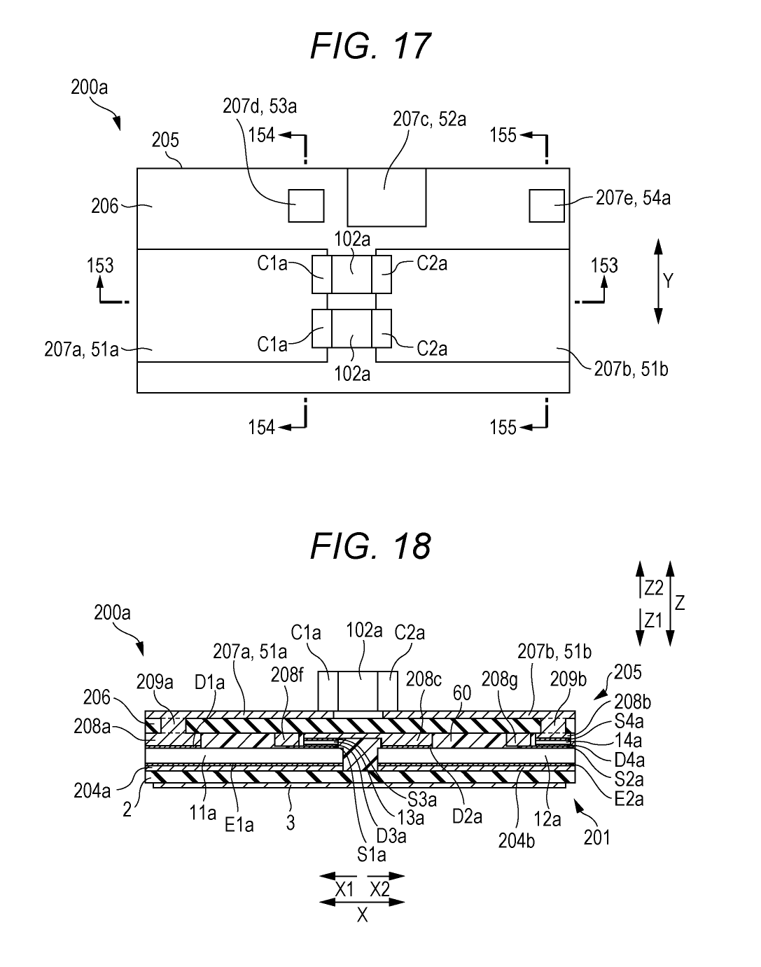

Next, with reference to FIGS. 17 to 26, a power module 200a according to a second embodiment will be described. In the first embodiment as described above, the first horizontal switching element 11a and the second horizontal switching element 12a are arranged such that their front faces face the opposite directions to each other. Unlike this, in the second embodiment, an example in which the first horizontal switching element 11a and the second horizontal switching element 12a are arranged such that their front faces both face the same direction will be described. It is noted that the power module 200a is an example of the “power conversion apparatus.”

First, the configuration of the power module 200a according to the second embodiment will be described with reference to FIGS. 17 to 25. It is noted that the power module 200a performs the power conversion of the U-phase in the three-phase inverter apparatus. That is, in the second embodiment, two power modules (power modules adapted to perform the power conversion of the V-phase and the W-phase) that have substantially the same configuration as the power module 200a are provided separately from the power module 200a, similarly to the above-described first embodiment. In the following, only the power module 200a, which performs the power conversion of the U-phase, will be described for simplifying the description.

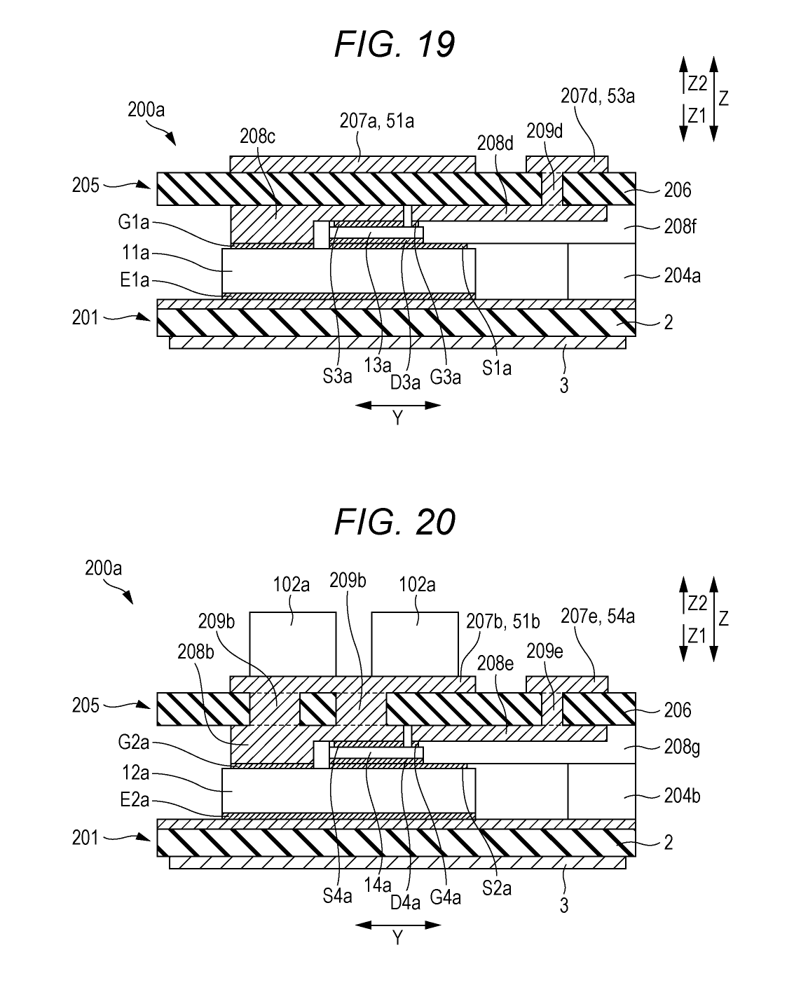

As illustrated in FIGS. 17 to 20, the power module 200a includes a first substrate 201, two horizontal switching elements (the first horizontal switching element 11a and the second horizontal switching element 12a), two controlling switching elements (the first controlling switching element 13a and the second controlling switching element 14a), two snubber capacitors 102a, and a second substrate 205. Further, the seal resin 60 is filled between the upper face (the face on the arrow Z2 direction side) of the first substrate 201 and the lower face (the face on the arrow Z1 direction side) of the second substrate 205. It is noted that, in FIGS. 19 and 20, the depiction of the seal resin 60 is omitted for convenience of illustration.

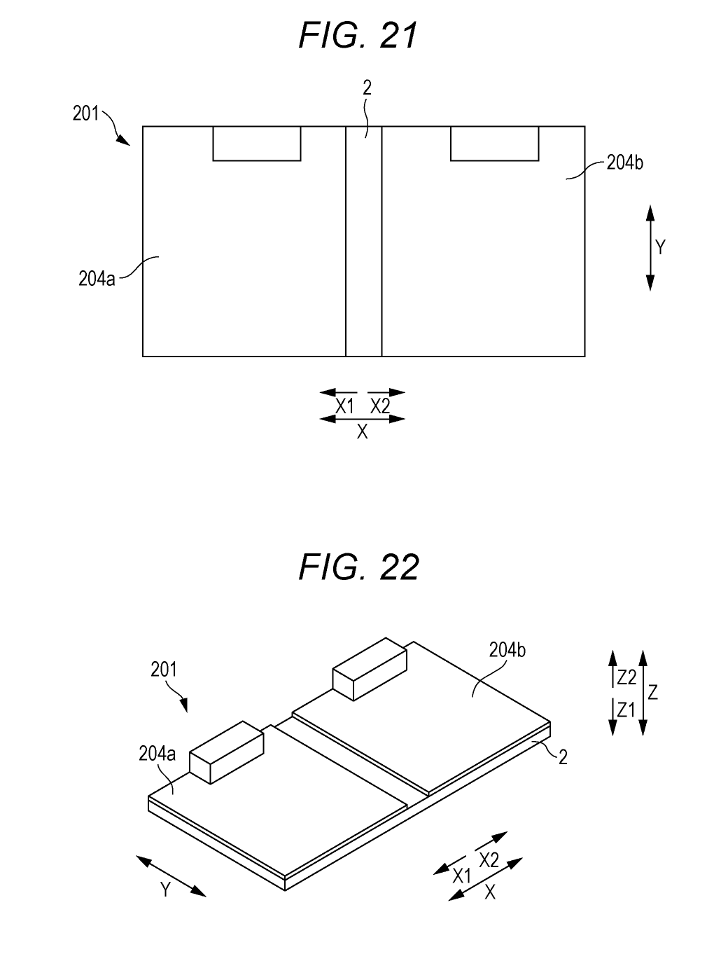

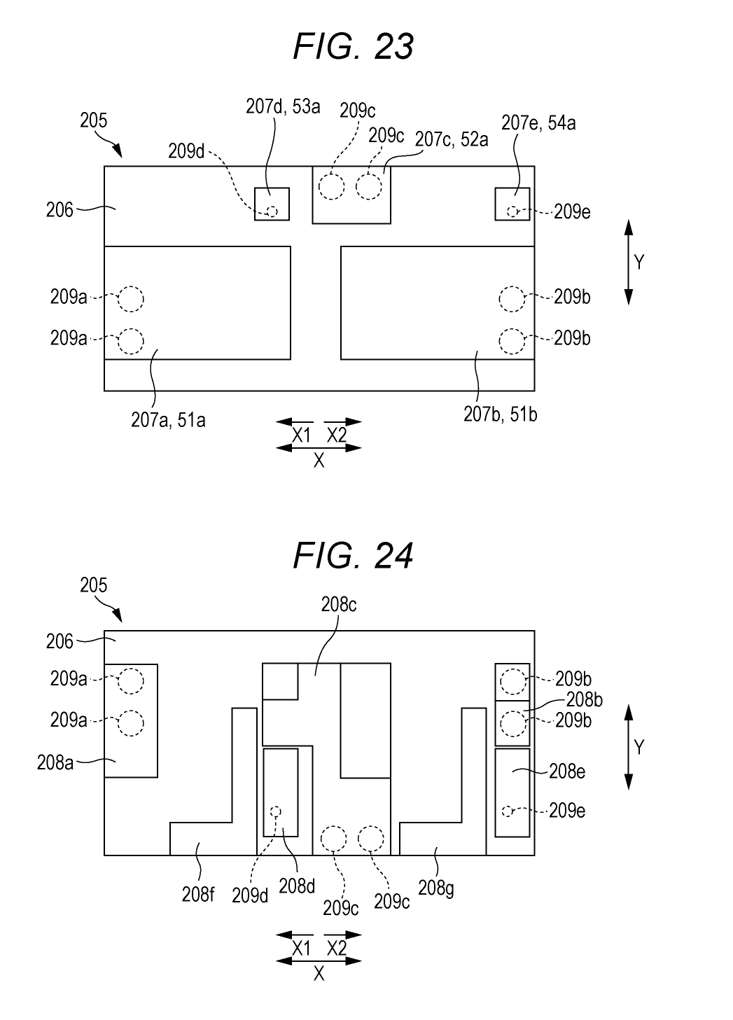

Further, as illustrated in FIGS. 21 and 22, the first substrate 201 includes the insulating sheet 2 and two conductive patterns 204a and 204b formed on the upper face (the face on the arrow Z2 direction side) of the insulating sheet 2. The heat radiation layer 3 (see FIGS. 18 to 20) is formed on the lower face (the face on the arrow Z1 direction side) of the insulating sheet 2 of the first substrate 201. Further, as illustrated in FIGS. 23 to 25, the second substrate 205 includes an insulating sheet 206, five conductive patterns 207a, 207b, 207c, 207d, and 207e formed on the upper face of the insulating sheet 206, and seven conductive patterns 208a, 208b, 208c, 208d, 208e, 208f, and 208g formed on the lower face of the insulating sheet 206.

It is noted that the conductive patterns 207a, 207b, 207c, 207d, and 207e and the conductive patterns 208a, 208b, 208c, 208d, and 208e are electrically connected via pillar conductors 209a, 209b, 209c, 209d, and 209e provided so as to penetrate the insulating sheet 206 in the vertical direction (the Z direction), respectively.

Here, as illustrated in FIGS. 18 to 20, in the second embodiment, the second substrate 205 is arranged so as to be interposed between the snubber capacitors 102a and the first and second horizontal switching elements 11a and 12a, similarly to the above-described first embodiment. That is, the conductive patterns 207a to 207e and 208a to 208g and the pillar conductors 209a to 209e provided on the second substrate 205 are arranged so as to be interposed between the snubber capacitors 102a and both of the first horizontal switching element 11a and the second horizontal switching element 12a. It is noted that the conductive patterns 207a to 207e and 208a to 208g and the pillar conductors 209a to 209e are an example of the “connecting conductor.”

As illustrated in FIG. 18, one electrode C1a of the snubber capacitor 102a is connected to the conductive pattern 207a on the upper face (the face on the arrow Z2 direction side) of the second substrate 205. The conductive pattern 207a is connected to the drain electrode D1a of the first horizontal switching element 11a via the pillar conductor 209a and the conductive pattern 208a on the lower face (the face on the arrow Z1 direction side) of the second substrate 205. Thus, the conductive patterns 207a and 208a and the pillar conductor 209a are arranged so as to be interposed between the one electrode C1a of the snubber capacitor 102a and the drain electrode D1a of the first horizontal switching element 11a. It is noted that the conductive patterns 207a and 208a are examples of the “first conductive pattern” and the “second conductive pattern”, respectively. Further, the conductive patterns 207a and 208a and the pillar conductor 209a are an example of the “first connecting conductor.”

Further, the other electrode C2a of the snubber capacitor 102a is connected to the conductive pattern 207b on the upper face (the face on the arrow Z2 direction side) of the second substrate 205. The conductive pattern 207b is connected to the source electrode S2a of the second horizontal switching element 12a via the pillar conductor 209b, the conductive pattern 208b on the lower face (the face on the arrow Z1 direction side) of the second substrate 205, and the second controlling switching element 14a. Thus, the conductive patterns 207b and 208b and the pillar conductor 209b are arranged so as to be interposed between the other electrode C2a of the snubber capacitor 102a and the source electrode S2a of the second horizontal switching element 12a. It is noted that the conductive patterns 207b and 208b are examples of the “first conductive pattern” and the “second conductive pattern”, respectively. Further, the conductive patterns 207b and 208b and the pillar conductor 209b are an example of the “second connecting conductor.”

Here, as illustrated in FIG. 18, in the second embodiment, the first horizontal switching element 11a and the second horizontal switching element 12a are arranged on the upper face (the face on the arrow Z2 direction side) of the first substrate 201 such that their front faces both face the same direction unlike the above-described first embodiment. Specifically, the electrode E1a on the rear face side of the first horizontal switching element 11a is joined to a conductive pattern 204a on the upper face of the first substrate 201 via a joining layer (not shown) including solder and the like. Further, the electrode E2a on the rear face side of the second horizontal switching element 12a is joined to a conductive pattern 204b on the upper face of the first substrate 201 via a joining layer (not shown) including solder and the like.

Further, in the second embodiment, the first controlling switching element 13a and the second controlling switching element 14a are arranged so as to be interposed between the first horizontal switching element 11a mounted on the upper face (the face on the arrow Z1 direction side) of the first substrate 201 and the second substrate 205 (that is, the conductive patterns) and between the second horizontal switching element 12a mounted on the upper face (the face on the arrow Z1 direction side) of the first substrate 201 and the second substrate 205 (that is, the conductive patterns), respectively. Further, the first controlling switching element 13a and the second controlling switching element 14a are arranged on the front faces of the first horizontal switching element 11a and the second horizontal switching element 12a, respectively, such that their front faces both face the same direction.

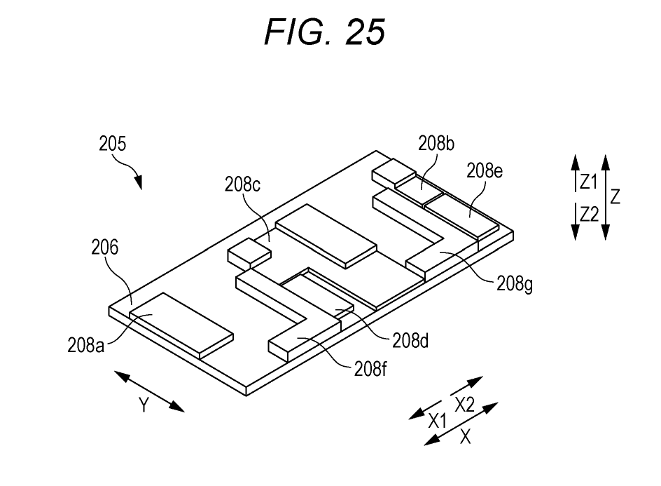

As illustrated in FIG. 18, the drain electrode D3a on the rear face side of the first controlling switching element 13a is joined to the source electrode S1a on the front face side of the first horizontal switching element 11a via a joining layer (not shown) including solder and the like. That is, the source electrode S1a on the front face side of the first horizontal switching element 11a and the drain electrode D3a on the rear face side of the first controlling switching element 13a are directly connected to each other without interposing a sheet conductor or the like. Further, the source electrode S3a and the gate electrode G3a on the front face side of the first controlling switching element 13a is joined to the conductive patterns 208c and 208d (see FIGS. 24 and 25) on the lower face (the face on the arrow Z1 direction side) of the second substrate 205 via a joining layer (not shown) including solder and the like, respectively.

Further, as illustrated in FIG. 18, the drain electrode D4a on the rear face side of the second controlling switching element 14a is joined to the source electrode S2a on the front face side of the second horizontal switching element 12a via a joining layer (not shown) including solder and the like. That is, the source electrode S2a on the front face side of the second horizontal switching element 12a and the drain electrode D4a on the rear face side of the second controlling switching element 14a are directly connected to each other without interposing a sheet conductor or the like. Further, the source electrode S4a and the gate electrode G4a on the front face side of the second controlling switching element 14a is joined to the conductive patterns 208b and 208e (see FIGS. 24 and 25) on the lower face of the second substrate 205 via a joining layer (not shown) including solder and the like, respectively.

It is noted that, in the second embodiment, as illustrated in FIGS. 24 and 25, two protrusion parts protruding to the first substrate 201 side (the arrow Z1 direction side) is provided to the conductive pattern 208c on the lower face (the face on the arrow Z1 direction side) of the second substrate 205. The smaller protrusion part, of these two protrusion parts, that is provided on the left side (the arrow X1 direction side) is joined to the gate electrode G1a on the front face side of the first horizontal switching element 11a via a joining layer (not shown) including solder and the like, as illustrated in FIG. 19. This provides an electrical connection between the gate electrode G1a of the first horizontal switching element 11a and the source electrode S3a of the first controlling switching element 13a via the conductive pattern 208c. Further, the larger protrusion part, of the above-described two protrusion parts, that is provided on the right side (the arrow X2 direction side) is joined to the drain electrode D2a of the second horizontal switching element 12a via a joining layer (not shown) including solder and the like, as illustrated in FIG. 18. The larger protrusion part of the conductive pattern 208c is provided for electrically connecting the source electrode S3a of the first controlling switching element 13a to the drain electrode D2a of the second horizontal switching element 12a. The source electrode S3a and the drain electrode D2a have mutually different heights from the upper face (the face on the arrow Z2 direction side) of the first substrate 201 (heights in the Z direction).

Further, as illustrated in FIGS. 24 and 25, a protrusion part protruding to the first substrate 201 side (the arrow Z1 direction side) is provided to the conductive pattern 208b on the lower face (the face on the arrow Z1 direction side) of the second substrate 205. This protrusion part of the conductive pattern 208b is joined to the gate electrode G2a on the front face side of the second horizontal switching element 12a via a joining layer (not shown) including solder and the like, as illustrated in FIG. 20. This provides an electrical connection between the gate electrode G2a of the second horizontal switching element 12a and the source electrode S4a of the second controlling switching element 14a via the conductive pattern 208b.

Further, as illustrated in FIGS. 21 and 22, a protrusion part protruding to the second substrate 205 side (the arrow Z2 direction side) is provided to each of the conductive patterns 204a and 204b on the upper face (the face on the arrow Z2 direction side) of the first substrate 201. As illustrated in FIGS. 19 and 20, the protrusion parts of the conductive patterns 204a and 204b are joined to the conductive patterns 208f and 208g on the lower face (the face on the arrow Z1 direction side) of the second substrate 205 via a joining layer (not shown) including solder and the like, respectively. This provides an electrical connection between the source electrode S1a (S2a) on the front face side of the first horizontal switching element 11a (the second horizontal switching element 12a) and the electrode E1a (E2a) on the rear face side via the conductive patterns 208f and 204a (208g and 204b).

With the configuration as described above, in the second embodiment, the conductive pattern 207a on the upper face (the face on the arrow Z2 direction side) of the second substrate 205 is connected to the drain electrode D1a of the first horizontal switching element 11a via the pillar conductor 209a and the conductive pattern 208a. Therefore, the conductive pattern 207a configures the input terminal 51a (see FIG. 1) connected to the direct current power source (not shown). Further, the conductive pattern 207b is connected to the source electrode S4a of the second controlling switching element 14a via the pillar conductor 209b and the conductive pattern 208b. Therefore, the conductive pattern 208b configures the input terminal 51b (see FIG. 1) connected to the direct current power source (not shown).

Further, the conductive pattern 207c on the upper face (the face on the arrow Z2 direction side) of the second substrate 205 is connected to the source electrode S3a of the first controlling switching element 13a and the drain electrode D2a of the second horizontal switching element 12a via the pillar conductor 209c and the conductive pattern 208c. Therefore, the conductive pattern 207c configures the output terminal 52a of the U-phase (see FIG. 1) connected to a motor (not shown) or the like.

Further, the conductive pattern 207d on the upper face (the face on the arrow Z2 direction side) of the second substrate 205 is connected to the gate electrode G3a of the first controlling switching element 13a via the pillar conductor 209d and the conductive pattern 208d. Therefore, the conductive pattern 207d configures the control terminal 53a (see FIG. 1) to which the control signal for switching the first controlling switching element 13a is inputted. Further, the conductive pattern 207e is connected to the gate electrode G4a of the second controlling switching element 14a via the pillar conductor 209e and the conductive pattern 208e. Therefore, the conductive pattern 207e configures the control terminal 54a (see FIG. 1) to which the control signal for switching the second controlling switching element 14a is inputted.

Incidentally, other configurations in the second embodiment are the same as those in the above-described first embodiment.

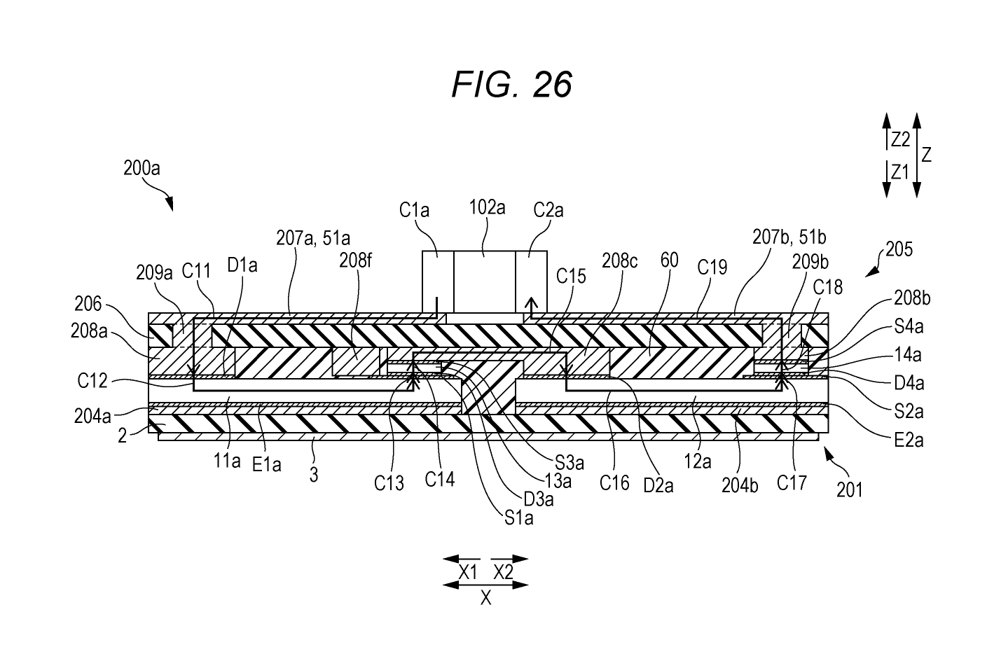

Next, with reference to FIGS. 1 and 26, current paths C11, C12, C13, C14, C15, C16, C17, C18, and C19 (see FIG. 26) of the power module 200a according to the second embodiment will be described. The current paths C11, C12, C13, C14, C15, C16, C17, C18, and C19 are formed by the current of I1, I2, I3, I4, I5, I6, I7, I8, and I9 (see FIG. 1) flowing between the snubber capacitors 102a and the first and second horizontal switching elements 11a and 12a, respectively.

As illustrated in FIG. 26, the current I1 flowing from the one electrode C1a of the snubber capacitor 102a to the drain electrode D1a of the first horizontal switching element 11a (see FIG. 1) flows in the left direction (the arrow X1 direction) via the conductive pattern 207a. The current I1 then flows in the downward direction (the arrow Z1 direction) via the pillar conductor 209a and the conductive pattern 208a. Thereby, the current path C11 has a longer section extending in the direction substantially parallel to the first substrate 201 and the second substrate 205, and a shorter section extending in the direction substantially orthogonal to the first substrate 201 and the second substrate 205. Then, the current I2 flowing from the drain electrode D1a to the source electrode S1a of the first horizontal switching element 11a (see FIG. 1) flows in the right direction (the arrow X2 direction) along the front face of the first horizontal switching element 11a. Thereby, the current path C12 extending in the direction substantially parallel to the first substrate 201 and the second substrate 205 is formed.

Here, in the second embodiment, the source electrode S1a on the front face side of the first horizontal switching element 11a and the drain electrode D3a on the rear face side of the first controlling switching element 13a are directly connected without interposing a sheet conductor and the like, as described above. Therefore, the current I3 flowing from the source electrode S1a of the first horizontal switching element 11a to the drain electrode D3a of the first controlling switching element 13a (see FIG. 1) flows in the upward direction (the arrow Z2 direction) for a very short distance between the source electrode S1a of the first horizontal switching element 11a and the drain electrode D3a of the first controlling switching element 13a. Thereby, the very short current path C13 extending in the direction substantially orthogonal to the first substrate 201 and the second substrate 205 is formed.

Next, the current I4 flowing from the drain electrode D3a to the source electrode S3a of the first controlling switching element 13a (see FIG. 1) flows inside the first controlling switching element 13a in the upward direction (the arrow Z2 direction) so as to be orthogonal to the front face and the rear face of the first controlling switching element 13a. Thereby, the current path C14 extending in the direction substantially orthogonal to the first substrate 201 and the second substrate 205 is formed. Further, the current I5 flowing from the source electrode S3a of the first controlling switching element 13a to the drain electrode D2a of the second horizontal switching element 12a (see FIG. 1) flows in the right direction (the arrow X2 direction) via the flat portion of the conductive patter 208c. The current I5 then flows in the downward direction (the arrow Z1 direction) via the right protrusion part of the conductive pattern 208c. Thereby, the current path C15 has a longer section extending in the direction substantially parallel to the first substrate 201 and the second substrate 205, and a shorter section extending in the direction substantially orthogonal to the first substrate 201 and the second substrate 205.

Next, the current I6 flowing from the drain electrode D2a to the source electrode S2a of the second horizontal switching element 12a (see FIG. 1) flows in the right direction (the arrow X2 direction) along the front face of the second horizontal switching element 12a. Thereby, the current path C16 extending in the direction substantially parallel to the first substrate 201 and the second substrate 205 is formed. Further, the current I7 flowing from the source electrode S2a of the second horizontal switching element 12a to the drain electrode D4a of the second controlling switching element 14a (see FIG. 1) flows in the upward direction (the arrow Z2 direction) for a very short distance between the source electrode S2a of the second horizontal switching element 12a and the drain electrode D4a of the second controlling switching element 14a, similarly to the above-described current I3 (see FIG. 1). Thereby, the very short current path C17 extending in the direction substantially orthogonal to the first substrate 201 and the second substrate 205 is formed.

Next, the current I8 flowing from the drain electrode D4a to the source electrode S4a of the second controlling switching element 14a (see FIG. 1) flows inside the second controlling switching element 14a in the upward direction (the arrow Z2 direction) so as to be substantially orthogonal to the front face and the rear face of the second controlling switching element 14a. Thereby, the current path C18 extending in the direction substantially orthogonal to the first substrate 201 and the second substrate 205 is formed. Further, the current I9 flowing from the source electrode S4a of the second controlling switching element 14a to the other electrodes C2a of the snubber capacitors 102a (see FIG. 1) flows in the upward direction (the arrow Z2 direction) via the conductive pattern 208b and the pillar conductor 209b. The current I9 then flows in the left direction (the arrow X1 direction) via the conductive pattern 207b. Thereby, the current path C19 has a shorter section extending in the direction substantially orthogonal to the first substrate 201 and the second substrate 205, and a longer section extending in the direction substantially parallel to the first substrate 201 and the second substrate 205.

As described above, the current paths C11 to C19 (see FIG. 26) are formed by the current I1 to I9 flowing between the snubber capacitors 102a and the first and second horizontal switching elements 11a and 12a (see FIG. 1). The current paths C11 to C19 include the current paths C12 and C11. The current path C12 is arranged between the drain electrode D1a and the source electrode S1a of the first horizontal switching element 11a. In the current path C12, the current flows in the horizontal direction (the arrow X2 direction) along the front face of the first horizontal switching element 11a. The direction of the current in the current path C11 is substantially opposite to that in the current path C12. The current paths C11 to C19 include the current paths C16 and C19. The current path C16 is arranged between the drain electrode D2a and the source electrode S2a of the second horizontal switching element 12a. In the current path C16, the current flows in the horizontal direction (the arrow X2 direction) along the front face of the second horizontal switching element 12a. The direction of the current in the current path C19 is substantially opposite to that in the current path C16. It is noted that the current paths C12 and C16 are an example of the “first current path” and the current paths C11 and C19 are an example of the “second current path.”

Here, the current path C12 (C16) and the current path C11 (C19) are arranged close to each other so as to be able to cancel the change in the magnetic flux generated due to the current flowing through the current paths C12 and C11 (C16 and C19). Specifically, the current path C12 (C16) and the current path C11 (C19) are spaced apart from each other by a distance that is substantially the same length as the total thickness in the vertical direction (the Z direction) of the second substrate 205 and the first controlling switching element 13a (the second controlling switching element 14a). It is noted that the current path C12 (C16) and the current path C11 (C19) are arranged to be opposed to each other.

In the second embodiment, the first controlling switching element 13a (the second controlling switching element 14a) is arranged so as to be interposed between the first horizontal switching element 11a (the second horizontal switching element 12a) mounted on the upper face (the face on the arrow Z2 direction side) of the first substrate 201 and the second substrate 205, as described above. Thus, the first controlling switching element 13a (the second controlling switching element 14a) can be held in a mechanically stable state between the first horizontal switching element 11a (the second horizontal switching element 12a) and the second substrate 205. Further, the drain electrode D3a (D4a) of the first controlling switching element 13a (the second controlling switching element 14a) can be directly connected to the source electrode S1a (S2a) on the front face side of the first horizontal switching element 11a (the second horizontal switching element 12a) without interposing the sheet conductor and the like. Thus, the drain electrode D3a (D4a) of the first controlling switching element 13a (the second controlling switching element 14a) is easily connected electrically to the source electrode S1a (S2a) of the first horizontal switching element 11a (the second horizontal switching element 12a). Further, the current path C13 (C17) between the first controlling switching element 13a (the second controlling switching element 14a) and the first horizontal switching element 11a (the second horizontal switching element 12a) is shortened. Thus, the wiring inductance can be reduced.

Further, in the second embodiment, the first horizontal switching element 11a and the second horizontal switching element 12a are arranged on the upper face (the face on the arrow Z2 direction side) of the first substrate 201 such that their front faces both face the same direction, as described above. Thus, the front face having the drain electrode D1a, the source electrode S1a, and the gate electrode G1a of the first horizontal switching element 11a, and the front face having the drain electrode D2a, the source electrode S2a, and the gate electrode G2a of the second horizontal switching element 12a both are arranged on the second substrate 205 side (the arrow Z2 direction side) on which the snubber capacitors 102a are arranged. Therefore, the current path between the snubber capacitors 102a and the first horizontal switching element 11a (the second horizontal switching element 12a) can be easily shortened. As a result, the wiring inductance between the snubber capacitors 102a and the first horizontal switching element 11a (the second horizontal switching element 12a) can be easily reduced.

Incidentally, other advantageous effects in the second embodiment are the same as those in the above-described first embodiment.

### Third Embodiment

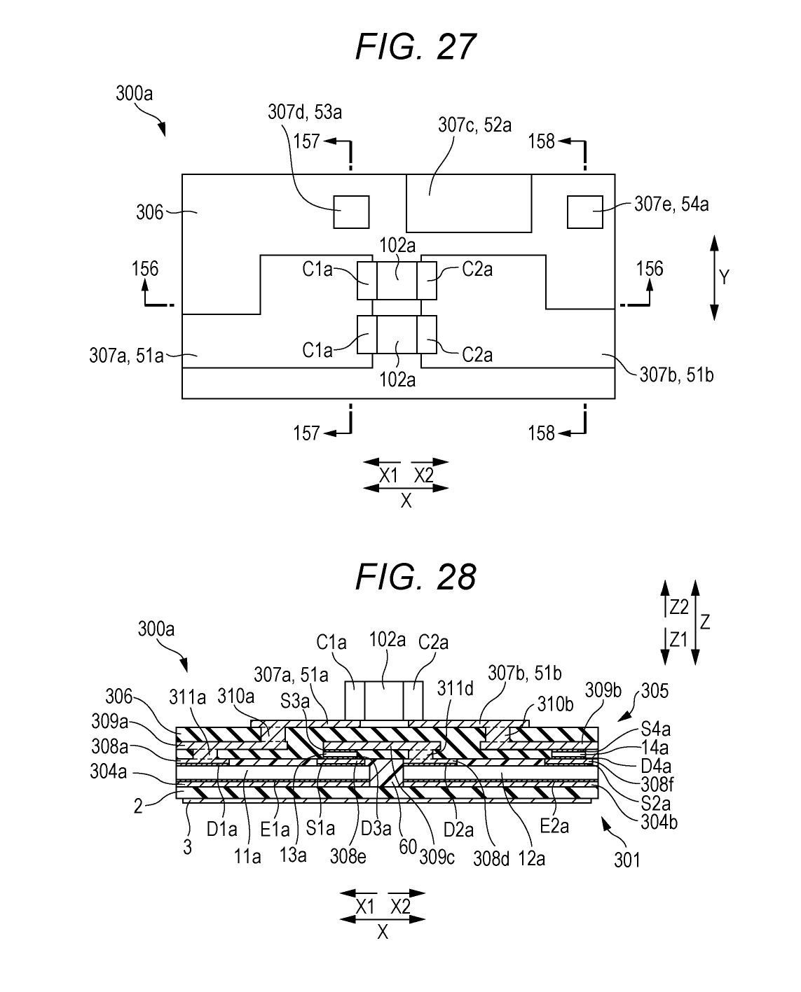

Next, with reference to FIGS. 27 to 37, a power module 300a according to a third embodiment will be described. In the second embodiment as described above, the first controlling switching element 13a (the second controlling switching element 14a) is interposed between the first horizontal switching element 11a (the second horizontal switching element 12a) and the second substrate 205. Unlike this, in the third embodiment, an example in which the first controlling switching element 13a (the second controlling switching element 14a) is embedded in a second substrate 305 will be described. It is noted that the power module 300a is an example of the “power conversion apparatus.”

First, the configuration of the power module 300a according to the third embodiment will be described with reference to FIGS. 27 to 36. It is noted that the power module 300a performs the power conversion of the U-phase in the three-phase inverter apparatus. That is, in the third embodiment, two power modules (power modules adapted to perform the power conversion of the V-phase and the W-phase) that have substantially the same configuration as the power module 300a are provided separately from the power module 300a, similarly to the above-described first and second embodiments. In the following, only the power module 300a, which performs the power conversion of the U-phase, will be described for simplifying the description.

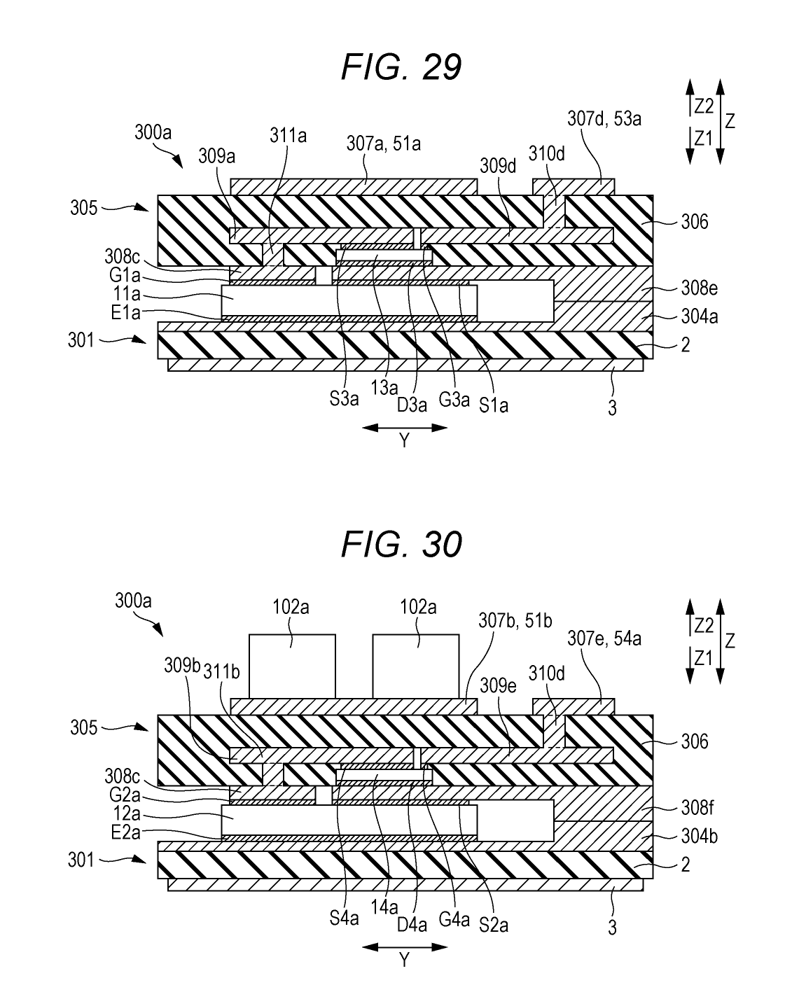

As illustrated in FIGS. 27 to 30, the power module 300a includes a first substrate 301, two horizontal switching elements (the first horizontal switching element 11a and the second horizontal switching element 12a), two controlling switching elements (the first controlling switching element 13a and the second controlling switching element 14a), two snubber capacitors 102a, and a second substrate 305. Further, the seal resin 60 is filled between the upper face (the face on the arrow Z2 direction side) of the first substrate 301 and the lower face (the face on the arrow Z1 direction side) of the second substrate 305. It is noted that, in FIGS. 29 and 30, the depiction of the seal resin 60 is omitted for convenience of illustration.

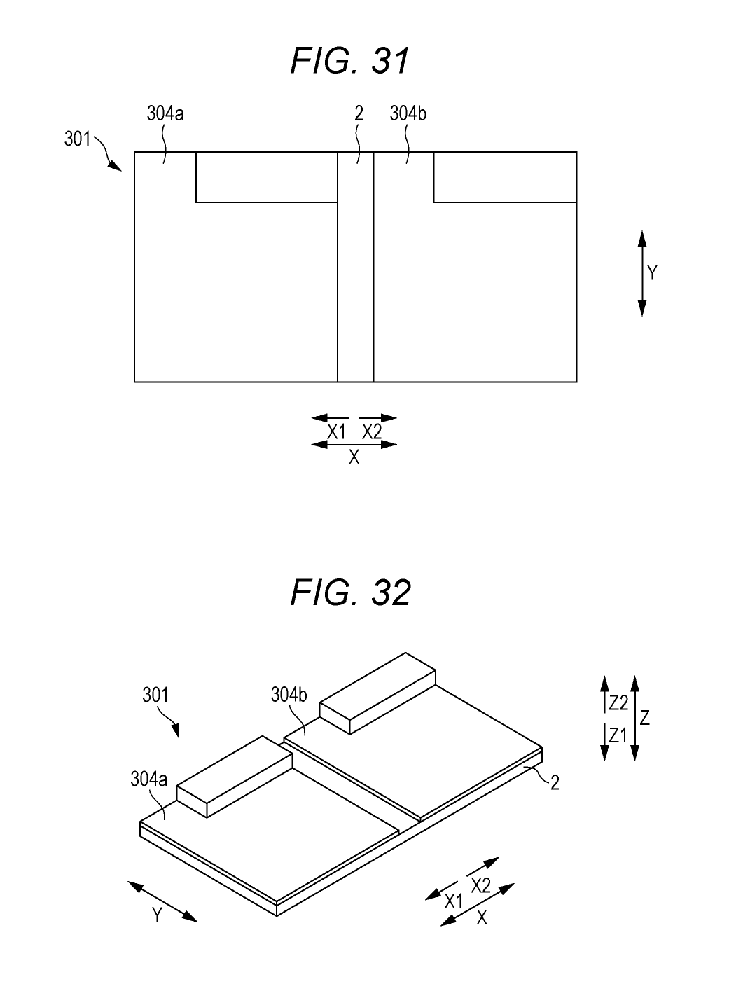

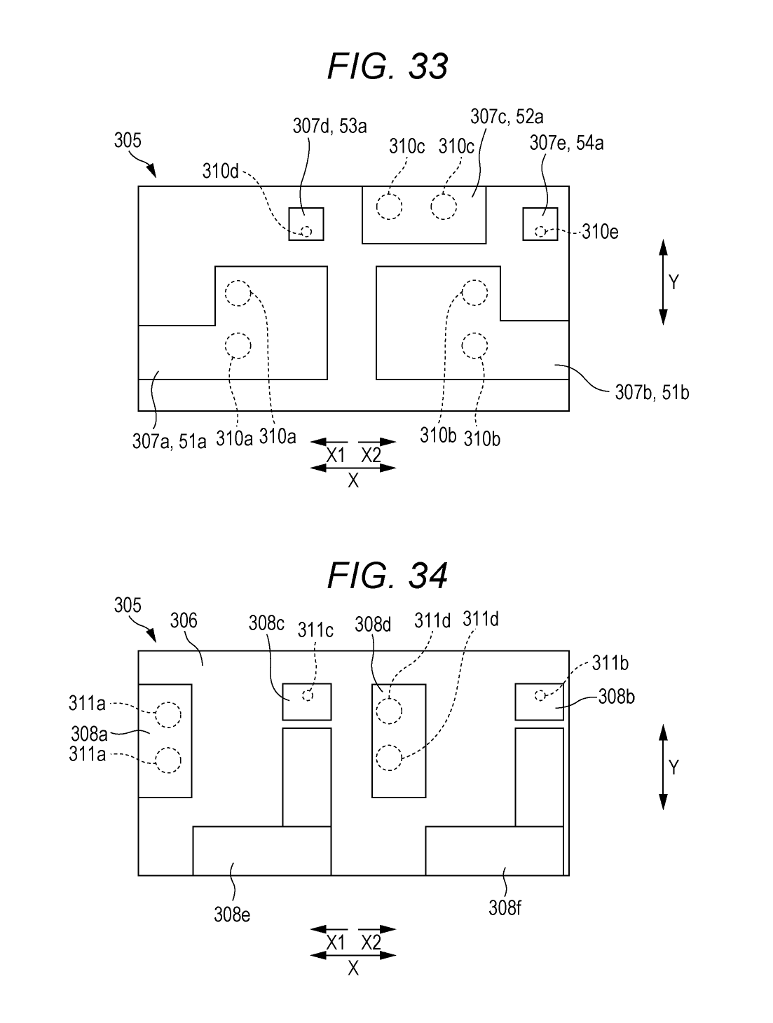

Further, as illustrated in FIGS. 31 and 32, the first substrate 301 includes the insulating sheet 2 and two conductive patterns 304a and 304b formed on the upper face (the face on the arrow Z2 direction side) of the insulating sheet 2. The heat radiation layer 3 (see FIGS. 28 to 30) is formed on the lower face (the face on the arrow Z1 direction side) of the insulating sheet 2 of the first substrate 301. Further, as illustrated in FIGS. 33 to 35, the second substrate 305 includes an insulating sheet 306, five conductive patterns 307a, 307b, 307c, 307d, and 307e formed on the upper face of the insulating sheet 306, and six conductive patterns 308a, 308b, 308c, 308d, 308e, and 308f formed on the lower face of the insulating sheet 306.

Here, in the third embodiment, as illustrated in FIGS. 28 to 30 and FIG. 36, five sheet conductors 309a, 309b, 309c, 309d, and 309e are embedded in the vicinity of the center in the vertical direction (the Z direction) of the second substrate 305.

The sheet conductor 309a is connected to the conductive pattern 307a on the upper face of the second substrate 305 via the pillar conductor 310a. The pillar conductor 310a is provided so as to extend toward the upper face (the face on the arrow Z2 direction side) of the second substrate 305. Further, the sheet conductor 309a is connected to the conductive pattern 308a on the lower face of the second substrate 305 via the pillar conductor 311a. The pillar conductor 311a is provided so as to extend toward the lower face (the face on the arrow Z1 direction side) of the second substrate 305. Similarly, the sheet conductor 309b is connected to the conductive pattern 307b on the upper face of the second substrate 305 via the pillar conductor 310b. Furthermore, the sheet conductor 309b is connected to the conductive pattern 308b on the lower face of the second substrate 305 via the pillar conductor 311b.

Further, the sheet conductor 309c is connected to the conductive pattern 307c on the upper face (the face on the arrow Z2 direction side) of the second substrate 305 via the pillar conductor 310c. Further, the sheet conductor 309c is connected to the conductive patterns 308c and 308d on the lower face (the face on the arrow Z1 direction side) of the second substrate 305 via the pillar conductors 311c and 311d. Incidentally, the sheet conductor 309d is connected to the conductive pattern 307d on the upper face of the second substrate 305 via the pillar conductor 310d. Further, the sheet conductor 309e is connected to the conductive pattern 307e on the upper face of the second substrate 305 via the pillar conductor 310e.

Further, in the third embodiment, as illustrated in FIGS. 28 to 30, the first controlling switching element 13a and the second controlling switching element 14a are embedded inside the second substrate 305. The first controlling switching element 13a is arranged so as to be interposed between the conductive pattern 308e on the lower face (the face on the arrow Z1 direction side) of the second substrate 305 and the sheet conductors 309c and 309d near the center in the vertical direction (the Z direction) of the second substrate 305. Further, the second controlling switching element 14a is arranged so as to be interposed between the conductive pattern 307f on the lower face of the second substrate 305 and the sheet conductors 309b and 309e near the center in the vertical direction of the second substrate 305.

Specifically, as illustrated in FIGS. 28 and 29, the source electrode S3a and the gate electrode G3a on the front face side of the first controlling switching element 13a are joined on the lower faces (the faces in the arrow Z1 direction side) of the sheet conductors 309c and 309d, respectively. Further, the drain electrode D3a on the rear face side of the first controlling switching element 13a is joined on the upper face of the conductive pattern 308e. Further, as illustrated in FIGS. 28 and 30, the source electrode S4a and the gate electrode G4a on the front face side of the second controlling switching element 14a are joined on the lower faces of the sheet conductors 309b and 309e, respectively. Further, the drain electrode D4a on the rear face side of the second controlling switching element 14a is joined on the upper face of the conductive pattern 307f.

In the third embodiment, the second substrate 305 is arranged so as to be interposed between the snubber capacitors 102a and the first and second horizontal switching elements 11a and 12a, similarly to the above-described second embodiment. Accordingly, the conductive patterns 307a to 307e and 308a to 308f, the sheet conductors 309a to 309e, and the pillar conductors 310a to 310e and 311a to 311d provided on the second substrate 305 are arranged so as to be interposed between the snubber capacitors 102a and the first and second horizontal switching elements 11a and 12a. It is noted that the conductive patterns 307a to 307e and 308a to 308f, the sheet conductors 309a to 309e, and the pillar conductors 310a to 310e and 311a to 311d are an example of the “connecting conductor.”

As illustrated in FIGS. 27 and 28, one electrodes C1a of the snubber capacitors 102a are connected to the conductive pattern 307a on the upper face (the face on the arrow Z2 direction side) of the second substrate 305. The conductive pattern 307a is connected to the drain electrode D1a of the first horizontal switching element 11a via the pillar conductor 310a, the sheet conductor 309a near the center in the vertical direction (the Z direction) of the second substrate 305, the pillar conductor 311a, and the conductive pattern 308a on the lower face (the face on the arrow Z1 direction side) of the second substrate 305, as illustrated in FIG. 28. Thus, the conductive patterns 307a and 308a, the sheet conductor 309a, and the pillar conductors 310a and 311a are arranged so as to be interposed between the one electrodes C1a of the snubber capacitors 102a and the drain electrode D1a of the first horizontal switching element 11a. It is noted that the conductive patterns 307a and 308a are examples of the “first conductive pattern” and the “second conductive pattern”, respectively. Further, the conductive patterns 307a and 308a, the sheet conductor 309a, and the pillar conductors 310a and 311a are an example of the “first connecting conductor.”

Further, the other electrodes C2a of the snubber capacitors 102a are connected to the conductive pattern 307b on the upper face (the face on the arrow Z2 direction side) of the second substrate 305. The conductive pattern 307b is connected to the source electrode S2a of the second horizontal switching element 12a via the pillar conductor 310b, the sheet conductor 309b near the center in the vertical direction (the Z direction) of the second substrate 305, the second controlling switching element 14a, and the conductive pattern 308f on the lower face (the face on the arrow Z1 direction side) of the second substrate 305. Thus, the conductive patterns 307b and 308f, the sheet conductor 309b, and the pillar conductor 310b are arranged so as to be interposed between the other electrodes C2a of the snubber capacitors 102a and the source electrode S2a of the second horizontal switching element 12a. It is noted that the conductive patterns 307b and 308f are examples of the “first conductive pattern” and the “second conductive pattern”, respectively. Further, the conductive patterns 307b and 308f, the sheet conductor 309b, and the pillar conductor 310b are an example of the “second connecting conductor.”

Further, in the third embodiment, the first horizontal switching element 11a and the second horizontal switching element 12a are arranged on the upper face (the face on the arrow Z2 direction side) of the first substrate 301 such that their front faces both face the same direction, similarly to the above-described second embodiment. Specifically, the electrode E1a on the rear face side of the first horizontal switching element 11a is connected to the conductive pattern 304a of the first substrate 301, as illustrated in FIG. 28. Further, the electrode E2a on the rear face side of the second horizontal switching element 12a is connected to the conductive pattern 304b of the first substrate 301.

Further, as illustrated in FIGS. 28 and 29, the drain electrode D1a, the source electrode S1a, and the gate electrode G1a on the front face side of the first horizontal switching element 11a are joined to the conductive patterns 308a, 308e, and 308c on the lower face (the face on the arrow Z1 direction side) of the second substrate 305 via a joining layer (not shown) including solder and the like, respectively. Further, as illustrated in FIGS. 28 and 30, the drain electrode D2a, the source electrode S2a, and the gate electrode G2a on the front face side of the second horizontal switching element 12a are joined to the conductive patterns 308d, 308f, and 308b on the lower face of the second substrate 305 via a joining layer (not shown) including solder and the like, respectively.

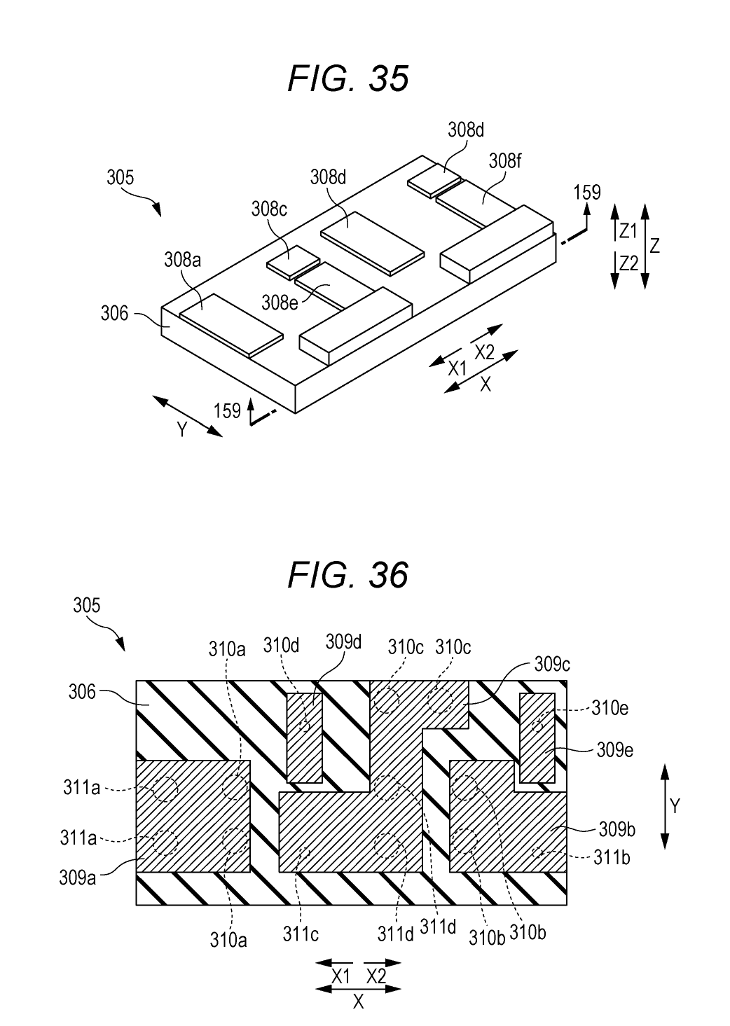

It is noted that, in the third embodiment, as illustrated in FIGS. 34 and 35, a protrusion part protruding to the first substrate 301 side (the arrow Z1 direction side) is provided to the conductive pattern 308e on the lower face (the face on the arrow Z1 direction side) of the second substrate 305. Further, as illustrated in FIGS. 31 and 32, a protrusion part protruding to the second substrate 305 side (the arrow Z2 direction side) is provided to a portion of the conductive pattern 304a provided on the upper face (the face on the arrow Z2 direction side) of the first substrate 301 and corresponding to the above-described protrusion part of the conductive pattern 308e. The protrusion part of the conductive pattern 308e and the protrusion part of the conductive pattern 304a are joined to each other via a joining layer (not shown) including solder and the like. This provides an electrical connection between the source electrode S1a on the front face side of the first horizontal switching element 11a and the electrode E1a on the rear face side via the conductive patterns 308e and 304a, as illustrated in FIG. 29.

Similarly, as illustrated in FIGS. 34 and 35, a protrusion part protruding to the first substrate 301 side (the arrow Z1 direction side) is provided to the conductive pattern 308f on the lower face (the face on the arrow Z1 direction side) of the second substrate 305. Further, as illustrated in FIGS. 31 and 32, a protrusion part protruding to the second substrate 305 side (the arrow Z2 direction side) is provided to a portion of the conductive pattern 304b provided on the upper face (the face on the arrow Z2 direction side) of the first substrate 301 and corresponding to the above-described protrusion part of the conductive pattern 308f. Further, the protrusion part of the conductive pattern 308f and the protrusion part of the conductive pattern 304b are joined to each other via a joining layer (not shown) including solder and the like. This provides an electrical connection between the source electrode S2a on the front face side of the second horizontal switching element 12a and the electrode E2a on the rear face side of the second horizontal switching element 12a via the conductive patterns 308f and 304b, as illustrated in FIG. 30.

With the configuration as described above, in the third embodiment, the conductive pattern 307a on the upper face (the arrow Z2 direction side) of the second substrate 305 is connected to the drain electrode D1a of the first horizontal switching element 11a via the pillar conductor 310a, the sheet conductor 309a, the pillar conductor 311a, and the conductive pattern 308a. Therefore, the conductive pattern 307a configures the input terminal 51a (see FIG. 1) connected to the direct current power source (not shown). Further, the conductive pattern 307b is connected to the source electrode S4a of the second controlling switching element 14a via the pillar conductor 310b and the sheet conductor 309b. Therefore, the conductive pattern 307b configures the input terminal 51b (see FIG. 1) connected to the direct current power source (not shown).

Further, the conductive pattern 307c on the upper face (the face on the arrow Z2 direction side) of the second substrate 305 is connected to the source electrode S3a of the first controlling switching element 13a via the pillar conductor 310c and the sheet conductor 309c. Further, the conductive pattern 307c is connected to the drain electrode D2a of the second horizontal switching element 12a via the pillar conductor 310c, the sheet conductor 309c, the pillar conductor 311d, and the conductive pattern 308d. Therefore, the conductive pattern 307c configures the output terminal 52a of the U-phase (see FIG. 1) connected to a motor (not shown) or the like.

Further, the conductive pattern 307d on the upper face (the face on the arrow Z2 direction side) of the second substrate 305 is connected to the gate electrode G3a of the first controlling switching element 13a via the pillar conductor 310d and the sheet conductor 309d. Therefore, the conductive pattern 307d configures the control terminal 53a (see FIG. 1) to which the control signal for switching the first controlling switching element 13a is inputted. Further, the conductive pattern 307e is connected to the gate electrode G4a of the second controlling switching element 14a via the pillar conductor 310e and the sheet conductor 309e. Therefore, the conductive pattern 307e configures the control terminal 53b (see FIG. 1) to which the control signal for switching the second controlling switching element 14a is inputted.

Incidentally, other configurations in the third embodiment are the same as those in the above-described second embodiment.

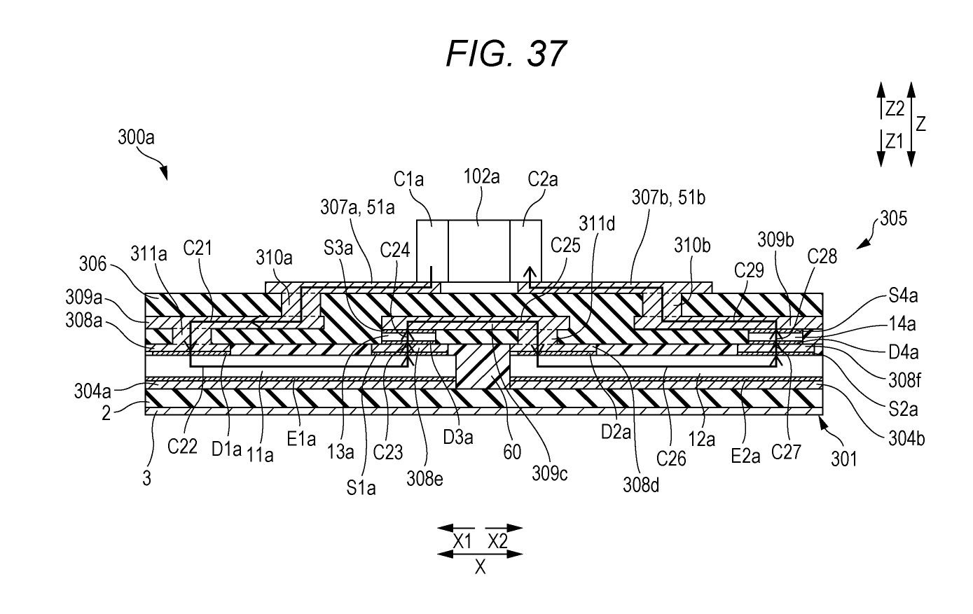

Next, with reference to FIGS. 1 and 37, current paths C21, C22, C23, C24, C25, C26, C27, C28, and C29 (see FIG. 37) of the power module 300a according to the third embodiment will be described. The current paths C21, C22, C23, C24, C25, C26, C27, C28, and C29 are formed by the current of I1, I2, I3, I4, I5, I6, I7, I8, and I9 (see FIG. 1) flowing between the snubber capacitors 102a and the first and second horizontal switching elements 11a and 12a, respectively.

As illustrated in FIG. 37, the current I1 flowing from the one electrodes C1a of the snubber capacitors 102a to the drain electrode D1a of the first horizontal switching element 11a (see FIG. 1) first flows in the left direction (the arrow X1 direction) via the conductive pattern 307a. Then, the current I1 flows in the downward direction (the arrow Z1 direction) via the pillar conductor 310a. The current I1, which has flown in the downward direction via the pillar conductor 310a, then flows in the horizontal direction via the sheet conductor 309a. The current I1 then flows in the downward direction via the pillar conductor 311a and the conductive pattern 308a. Thereby, the current path C21 has two longer sections extending in the direction substantially parallel to the first substrate 301 and the second substrate 305, and two shorter sections extending in the direction substantially orthogonal to the first substrate 301 and the second substrate 305.

Next, the current I2 flowing from the drain electrode D1a to the source electrode S1a of the first horizontal switching element 11a (see FIG. 1) flows in the right direction (the arrow X2 direction) inside and near the front face of the first horizontal switching element 11a. Thereby, the long current path C22 extending in the direction substantially parallel to the first substrate 301 and the second substrate 305 is formed. Further, the current I3 flowing from the source electrode S1a of the first horizontal switching element 11a to the drain electrode D3a of the first controlling switching element 13a (see FIG. 1) flows in the upward direction (the arrow Z2 direction) via the conductive pattern 308e. Thereby, the short current path C23 extending in the direction substantially orthogonal to the first substrate 301 and the second substrate 305 is formed.

Next, the current I4 flowing from the drain electrode D3a to the source electrode S3a of the first controlling switching element 13a (see FIG. 1) flows inside the first controlling switching element 13a in the upward direction (the arrow Z2 direction) so as to be orthogonal to the front face and the rear face of the first controlling switching element 13a. Thereby, the current path C24 extending in the direction substantially parallel to the first substrate 301 and the second substrate 305 is formed. Further, the current I5 flowing from the source electrode S3a of the first controlling switching element 13a to the drain electrode D2a of the second horizontal switching element 12a (see FIG. 1) flows in the right direction (the arrow X2 direction) via the sheet conductor 309c. The current I5 then flows in the downward direction via the pillar conductor 311d and the conductive pattern 308d. Thereby, the current path C25 has a longer section extending in the direction substantially parallel to the first substrate 301 and the second substrate 305, and a shorter section extending in the direction substantially orthogonal to the first substrate 301 and the second substrate 305.

Next, the current I6 flowing from the drain electrode D2a to the source electrode S2a of the second horizontal switching element 12a (see FIG. 1) flows in the right direction (the arrow X2 direction) inside and near the front face of the second horizontal switching element 12a. Thereby, the current path C26 extending in the direction substantially parallel to the first substrate 301 and the second substrate 305 is formed. Further, the current I7 flowing from the source electrode S2a of the second horizontal switching element 12a to the drain electrode D4a of the second controlling switching element 14a (see FIG. 1) flows in the upward direction (the arrow Z2 direction side) via the conductive pattern 308f. Thereby, the short current path C27 extending in the direction substantially orthogonal to the first substrate 301 and the second substrate 305 is formed.

Next, the current I8 flowing from the drain electrode D4a to the source electrode S4a of the second controlling switching element 14a (see FIG. 1) flows inside the second controlling switching element 14a in the upward direction (the arrow Z2 direction side) so as to be orthogonal to the front face and the rear face of the second controlling switching element 14a. Thereby, the current path C28 extending in the direction substantially orthogonal to the first substrate 301 and the second substrate 305 is formed. Further, the current I9 flowing from the source electrode S4a of the second controlling switching element 14a to the other electrodes C2a of the snubber capacitors 102a (see FIG. 1) first flows in the left direction (the arrow X1 direction) via the sheet conductor 309b. Then, the current I9 flows in the upward direction via the pillar conductor 310b. The current, which has flown in the upward direction via the pillar conductor 310b, then flows in the left direction via the conductive pattern 307b. Thereby, the current path C29 has two longer sections extending in the direction substantially parallel to the first substrate 301 and the second substrate 305, and one shorter section extending in the direction substantially orthogonal to the first substrate 301 and the second substrate 305.

As described above, the current paths C21 to C29 (see FIG. 37) are formed by the current I1 to I9 flowing between the snubber capacitors 102a and the first and second horizontal switching elements 11a and 12a (see FIG. 1). The current paths C21 to C29 include the current paths C22 and C21. The current path C22 is arranged between the drain electrode D1a and the source electrode S1a of the first horizontal switching element 11a. In the current path C22, the current flows in the horizontal direction (the arrow X2 direction) along the front face of the first horizontal switching element 11a. The direction of the current in the current path C21 is substantially opposite to that in the current path C22. The current paths C21 to C29 include the current paths C26 and C29. The current path C26 is arranged between the drain electrode D2a to the source electrode S2a of the second horizontal switching element 12a. In the current path C26, the current flows in the horizontal direction (the arrow X2 direction) along the front face of the second horizontal switching element 12a. The direction of the current in the current path C29 is substantially opposite to that in the current path C26. It is noted that the current paths C22 and C26 are an example of the “first current path” and the current paths C21 and C29 are an example of the “second current path.”

Here, the current path C22 (C26) and the current path C21 (C29) are arranged close to each other so as to be able to cancel the change in the magnetic flux generated due to the current flowing through these current paths C22 and C21 (C26 and C29). Specifically, the current path C22 (C26) and the current path C21 (C29) are arranged spaced apart from each other by a distance that is substantially the same length as the thickness in the vertical direction (the Z direction) of the second substrate 305. It is noted that the current path C22 (C26) and the current path C21 (C29) are arranged to be opposed to each other.

In the third embodiment, the first controlling switching element 13a and the second controlling switching element 14a are embedded in the second substrate 305, as described above. Thus, by arranging the second substrate 305 on the front faces of the first horizontal switching element 11a and the second horizontal switching element 12a, the connecting of the first horizontal switching element 11a and the first controlling switching element 13a and the connecting of the second horizontal switching element 12a and the second controlling switching element 14a can be performed together. As a result, the connecting operation of the first horizontal switching element 11a and the first controlling switching element 13a and the connecting operation of the second horizontal switching element 12a and the second controlling switching element 14a can be simplified.

Further, in the third embodiment, the current paths C21 to C29 (see FIG. 37) are formed between the snubber capacitors 102a, and the first and second horizontal switching elements 11a and 12a. Furthermore, the first controlling switching element 13a and the second controlling switching element 14a are embedded in the second substrate 305. Thus, the distance between the current paths C22 and C21 (C26 and C29) opposed to each other in which the current flows in the substantially opposite directions can be substantially the same as the thickness in the vertical direction (the Z direction) of the second substrate 305. On the other hand, in the above-described second embodiment, the distance between the current paths C12 and C11 (C16 and C29) opposed to each other in which the current flows in the opposite directions is substantially the same as the total thickness in the vertical direction (the Z direction) of the second substrate 205 and the first controlling switching element 13a (the second controlling switching element 14a) (see FIG. 26). In the third embodiment, the distance between the current paths C22 and C21 (C26 and C29) opposed to each other in which the current flows in the opposite directions can be shorter by the thickness of the first controlling switching element 13a (the second controlling switching element 14a), as compared with that in the second embodiment. As a result, the change in the magnetic flux generated by the current path C22 (C26) can be effectively offset by the change in the magnetic flux generated in the current path C21 (C29). This allows for further reduction of the wiring inductance between the snubber capacitors 102a and the first and second horizontal switching elements 11a and 12a.

Incidentally, other advantageous effects in the third embodiment are the same as those in the above-described second embodiment.

It should be understood that the embodiments disclosed herein are merely an example in all the points of view and not intended to be restricted thereto. The scope of the present disclosure is represented not by the description of the embodiments described above but by the claims and, furthermore, includes all modifications within the scope of the claims and the equivalent thereof.

For example, in the above-described first to third embodiments, the three-phase inverter apparatus is described as an example of the power conversion apparatus. However, the power conversion apparatus according to the embodiments of the present disclosure may be other power conversion apparatus than the three-phase inverter apparatus.

Further, in the examples indicated in the above-described first to third embodiments, the connecting conductors (various types of conductive patterns, pillar conductors, and sheet conductors) for connecting the horizontal switching element and the snubber capacitor are formed on the second substrate. The connecting conductors are thus interposed between the horizontal switching element and the snubber capacitor. In place of this, the connecting conductor may be arranged so as to be interposed between the horizontal switching element and the snubber capacitor without the second substrate being provided.

Further, in the above-described first to third embodiments, the normally-on horizontal switching element is used as an example. In place of this, a normally-off horizontal switching element may be used in the embodiments of the present disclosure. In this case, the reliability of the power module can be enhanced even when it has no normally-off controlling switching element which is cascode-connected to the horizontal switching element.

Further, in the above-described first to third embodiments, two snubber capacitors are provided for one power module (the power conversion apparatus), as an example. However, the number of the snubber capacitors provided for one power module (one power conversion apparatus) may be one or may be three or more.

Further, in the above-described first to third embodiments, an example in which the MOSFET (field effect transistor) is used as the horizontal switching element is described. In place of this, other transistors such as an IGBT (insulated gate bipolar transistor) and the like may be used as the horizontal switching element. Further, other horizontal switching element than the transistor may be used as the horizontal switching element.

Further, the power conversion apparatus according to the embodiments of the present disclosure may be the following first to seventeenth power conversion apparatus. The first power conversion apparatus includes: a horizontal switching element (11a to 11c, 12a to 12c) including a front face and a rear face and having, on the front face side, a first electrode (D1a to D1c, D2a to D2c, S1a to S1c, S2a to S2c) and a second electrode (D1a to D1c, D2a to D2c, S1a to S1c, S2a to S2c) in which a current flows in a horizontal direction parallel to the front face and the rear face between the first electrode and the second electrode; a snubber capacitor (102a to 102c) electrically connected to the horizontal switching element; and a connecting conductor (7a to 7e, 8a to 8f, 9a to 9e, 207a to 207e, 208a to 208g, 209a to 209e, 307a to 307e, 308a to 308f, 309a to 309e, 310a to 310e, 311a to 311d) arranged to be interposed between the horizontal switching element and the snubber capacitor, and a current path (C1 to C9, C11 to C19, C21 to C29) in which the snubber capacitor and the horizontal switching element are electrically connected via the connecting conductor is formed.

In the first power conversion apparatus, the second power conversion apparatus further has a controlling switching element (13a to 13c, 14a to 14c) cascode-connected to the horizontal switching element and configured to control driving of the horizontal switching element.

In the third power conversion apparatus in the second power conversion apparatus, the horizontal switching element has a third electrode (G1a to G1c, G2a to G2c) for control, in addition to the first electrode and the second electrode, and at least the third electrode of the horizontal switching element is connected to an electrode (S3a to S3c, S4a to S4c) where a current of the controlling switching element flows in or out.

In the fourth power conversion apparatus in any one of the first to third power conversion apparatus, the current path in which the snubber capacitor and the horizontal switching element are electrically connected via the connecting conductor includes a first current path (C2, C6, C12, C16, C22, C26) in which a current flows in a horizontal direction between the first electrode and the second electrode of the horizontal switching element and a second current path (C5, C9, C11, C19, C21, C29) in which a current flows in a direction opposite to the first current path, and the first current path and the second current path are arranged close to each other to be able to cancel changes in their magnetic flux.

In the fifth power conversion apparatus in the fourth power conversion apparatus, the first current path and the second current path are arranged to be opposed to each other.

In any one of the first to fifth power conversion apparatus, the sixth power conversion apparatus further has a first substrate (1, 201, 301), on a front face of which the horizontal switching element is mounted, and the horizontal switching element is arranged to be interposed between the first substrate and the connecting conductor.

In any one of the first to sixth power conversion apparatus, the seventh power conversion apparatus further has a controlling switching element (13a to 13c, 14a to 14c) cascode-connected to the horizontal switching element and configured to control driving of the horizontal switching element, the controlling switching element in addition to the horizontal switching element is arranged to be interposed between the first substrate and the connecting conductor.

In the eighth power conversion apparatus in the seventh power conversion apparatus, the controlling switching element is arranged to be interposed between the horizontal switching element mounted on the front face of the first substrate and the connecting conductor.

In the sixth or seventh power conversion apparatus, the ninth power conversion apparatus further has a second substrate (305) including the connecting conductor, and the controlling switching element is embedded in the second substrate.

In the tenth power conversion apparatus in the sixth or seventh power conversion apparatus, the horizontal switching element includes a first horizontal switching element (11a to 11c) and a second horizontal switching element (12a to 12c), and the first horizontal switching element and the second horizontal switching element are arranged on the front face of the first substrate such that their front faces face the opposite directions to each other.

In the eleventh power conversion apparatus in the tenth power conversion apparatus, the controlling switching element includes a first controlling switching element (13a, 13b, 13c) and a second controlling switching element (14a, 14b, 14c) corresponding to the first horizontal switching element and the second horizontal switching element, respectively, and the first controlling switching element and the second controlling switching element are arranged in outside of the first horizontal switching element and the second horizontal switching element.

In the twelfth power conversion apparatus in any one of the sixth to ninth power conversion apparatus, the horizontal switching element includes a first horizontal switching element and a second horizontal switching element, and the first horizontal switching element and the second horizontal switching element are arranged on the first substrate such that their front faces both face the same direction.

In the thirteenth power conversion apparatus in any one of the sixth to twelfth power conversion apparatus, a heat radiation layer (3) is formed on the rear face side of the first substrate.

In the fourteenth power conversion apparatus in any one of the sixth to thirteenth power conversion apparatus, a seal resin (60) is filled between the first substrate and the connecting conductor.

In any one of the sixth to twelfth power conversion apparatus, the fifteenth power conversion apparatus further has a second substrate (5, 205, 305) including the connecting conductor, the connecting conductor of the second substrate includes a first conductive pattern (7a, 7b, 207a, 207b, 307a, 307b) provided on the front face side of the second substrate and a second conductive pattern (8a, 8b, 208a, 208b, 308a, 308f) electrically connected to the first conductive pattern and provided on the rear face side with respect to the first conductive pattern of the second substrate, the snubber capacitor is connected to the first conductive pattern, and the horizontal switching element is connected to the second conductive pattern.

In the sixteenth power conversion apparatus in any one of the first to fifteenth power conversion apparatus, the horizontal switching element includes a first horizontal switching element and a second horizontal switching element, and the connecting conductor includes a first connecting conductor (7a, 8a, 9a, 207a, 208a, 209a, 307a, 308a, 309a, 310a, 311a) arranged so as to be interposed between the first horizontal switching element and the snubber capacitor and a second connecting conductor (7b, 8b, 9b, 207b, 208b, 209b, 307b, 308f, 309b, 310b) arranged so as to be interposed between the second horizontal switching element and the snubber capacitor.

In the seventeenth power conversion apparatus in any one of the first to sixteenth power conversion apparatus, the snubber capacitor includes a plurality of snubber capacitors, and the connecting conductor is shared by the plurality of snubber capacitors.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A power conversion apparatus comprising:
a horizontal switching element (11a to 11c, 12a to 12c) with a front face and a rear face, the horizontal switching element including a first electrode (D1a to D1c, D2a to D2c, S1a to S1c, S2a to S2c) and a second electrode (D1a to D1c, D2a to D2c, S1a to S1c, S2a to S2c) on a front face side;
a snubber capacitor (102a to 102c); and
a connecting conductor (7a to 7e, 8a to 8f, 9a to 9e, 207a to 207e, 208a to 208g, 209a to 209e, 307a to 307e, 308a to 308f, 309a to 309e, 310a to 310e, 311a to 311d) arranged to be interposed between the horizontal switching element and the snubber capacitor and electrically connecting the horizontal switching element to the snubber capacitor.

2. The power conversion apparatus according to claim 1 further comprising
a controlling switching element (13a to 13c, 14a to 14c) cascode-connected to the horizontal switching element and configured to control driving of the horizontal switching element.

3. The power conversion apparatus according to claim 2, wherein
the horizontal switching element includes a third electrode (G1a to G1c, G2a to G2c) for control, in addition to the first electrode and the second electrode, and
at least the third electrode of the horizontal switching element is connected to an electrode (S3a to S3c, S4a to S4c) where a current of the controlling switching element flows in or out.

4. The power conversion apparatus according to claim 1 further comprising:
a first current path (C2, C6, C12, C16, C22, C26) arranged between the first electrode and the second electrode of the horizontal switching element; and
a second current path (C5, C9, C11, C19, C21, C29) in which a current flows in a direction substantially opposite to a direction of a current in the first current path, wherein
the first current path and the second current path are arranged close to each other to cancel a change in magnetic flux.

5. The power conversion apparatus according to claim 4, wherein the first current path and the second current path are arranged to be opposed to each other.

6. The power conversion apparatus according to claim 1 further comprising
a first substrate (1, 201, 301) including a front face on which the horizontal switching element is mounted, wherein
the horizontal switching element is arranged to be interposed between the first substrate and the connecting conductor.

7. The power conversion apparatus according to claim 6 further comprising
a controlling switching element cascode-connected to the horizontal switching element and configured to control driving of the horizontal switching element, wherein
the controlling switching element, in addition to the horizontal switching element, is arranged to be interposed between the first substrate and the connecting conductor.

8. The power conversion apparatus according to claim 7, wherein the controlling switching element is arranged to be interposed between the horizontal switching element mounted on the front face of the first substrate and the connecting conductor.

9. The power conversion apparatus according to claim 8 further comprising
a second substrate (305) including the connecting conductor, wherein
the controlling switching element is embedded in the second substrate.

10. The power conversion apparatus according to claim 7, wherein
the horizontal switching element includes a first horizontal switching element (11a to 11c) and a second horizontal switching element (12a to 12c), and
the first horizontal switching element and the second horizontal switching element are arranged on the front face of the first substrate such that front faces of the first and second horizontal switching elements face opposite directions to each other.

11. The power conversion apparatus according to claim 10, wherein
the controlling switching element includes a first controlling switching element (13a, 13b, 13c) and a second controlling switching element (14a, 14b, 14c) corresponding to the first horizontal switching element and the second horizontal switching element, respectively, and
the first controlling switching element and the second controlling switching element are arranged outside the first horizontal switching element and the second horizontal switching element, respectively.

12. The power conversion apparatus according to claim 6, wherein
the horizontal switching element includes a first horizontal switching element and a second horizontal switching element, and
the first horizontal switching element and the second horizontal switching element are arranged on the front face of the first substrate such that front faces of the first and second horizontal switching elements face the same direction.

13. The power conversion apparatus according to claim 6 further comprising a heat radiation layer (3) formed on a rear face side of the first substrate.

14. The power conversion apparatus according to claim 6 further comprising a seal resin (60) filled between the first substrate and the connecting conductor.

15. The power conversion apparatus according to claim 1 further comprising
a second substrate (5, 205, 305) including the connecting conductor, wherein
the connecting conductor of the second substrate includes a first conductive pattern (7a, 7b, 207a, 207b, 307a, 307b) provided on a front face side of the second substrate and a second conductive pattern (8a, 8b, 208a, 208b, 308a, 308f) electrically connected to the first conductive pattern and provided on a rear face side of the second substrate,
the snubber capacitor is connected to the first conductive pattern, and
the horizontal switching element is connected to the second conductive pattern.

16. The power conversion apparatus according to claim 1, wherein
the horizontal switching element includes a first horizontal switching element and a second horizontal switching element, and
the connecting conductor includes a first connecting conductor (7a, 8a, 9a, 207a, 208a, 209a, 307a, 308a, 309a, 310a, 311a) arranged to be interposed between the first horizontal switching element and the snubber capacitor and a second connecting conductor (7b, 8b, 9b, 207b, 208b, 209b, 307b, 308f, 309b, 310b) arranged to be interposed between the second horizontal switching element and the snubber capacitor.

17. The power conversion apparatus according to claim 1 comprising
a plurality of the snubber capacitors, wherein
the connecting conductor is shared by the plurality of the snubber capacitors.
